(19) United States
(12) Patent Application Publication
(10) Pub. No.: US 2011/0267291 A1
(43) Pub. Date: Nov. 3, 2011

(54) IMAGE DISPLAY APPARATUS AND METHOD FOR OPERATING THE SAME

(76) Inventors: Jinyoung CHOI, Seoul (KR); Jonghyun LIM, Seoul (KR)

(21) Appl. No.: 12/972,375

(22) Filed: Dec. 17, 2010

Related U.S. Application Data
(60) Provisional application No. 61/367,769, filed on Jul. 26, 2010.
(60) Provisional application No. 61/367,776, filed on Jul. 26, 2010.

(30) Foreign Application Priority Data
Apr. 28, 2010 (KR) 10-2010-0039672
May 24, 2010 (KR) 10-2010-0048043

(51) Int. Cl. G06F 3/041

(52) U.S. Cl. 345/173

(57) ABSTRACT

An image display apparatus and a method for operating the same are discussed. The method according to an embodiment includes displaying a menu image including at least one selectable object on a display, displaying the menu image or the at least one object on a touch screen of a remote controller, and performing an operation corresponding to a touch pattern on the at least one object displayed on the touch screen.

### CROSS-REFERENCE TO RELATED APPLICATION

This application claims the benefit of Korean Patent Application Nos. 10-2010-0039672, filed on Apr. 28, 2010 and 10-2010-0048043, filed on May 24, 2010 in the Korean Intellectual Property Office and the benefit of U.S. Provisional Application Nos. 61/367,769 filed on Jul. 26, 2010 and 61/367,776 filed on Jul. 26, 2010 in the USPTO. The entire contents of each of the above-identified applications are incorporated herein by reference.

### BACKGROUND OF THE INVENTION

1. Field of the Invention

The present invention relates to an image display apparatus and a method for operating the same, and more particularly, to an image display apparatus and a method for operating the same, which increase user convenience.

2. Description of the Related Art

An image display apparatus has a function of displaying images to a user. The image display apparatus can display a broadcast program selected by the user on a display from among broadcast programs transmitted from broadcasting stations. The recent trend in broadcasting is a worldwide shift from analog broadcasting to digital broadcasting.

As it transmits digital audio and video signals, digital broadcasting offers many advantages over analog broadcasting, such as robustness against noise, less data loss, ease of error correction, and the ability to provide high-definition, clear images. Digital broadcasting also allows interactive viewer services, compared to analog broadcasting.

### SUMMARY OF THE INVENTION

Therefore, the present invention has been made in view of the above problems, and it is an object of the present invention to provide an image display apparatus and a method for operating the same, which can increase user convenience.

It is another object of the present invention to provide an image display apparatus and a method for operating the same, which enable a user to easily acquire desired information.

It is another object of the present invention to provide an image display apparatus and a method for operating the same, which can provide various user interfaces.

It is a further object of the present invention to provide an image display apparatus which can be controlled by a remote controller having a touch screen, and a method for operating the same.

In accordance with an aspect of the present invention, the above and other objects can be accomplished by the provision of a method for operating an image display apparatus, including displaying a menu image including at least one selectable object on a display, displaying the menu image or the at least one object on a touch screen of a remote controller, and performing an operation corresponding to a touch pattern on the at least one object displayed on the touch screen.

In accordance with another aspect of the present invention, there is provided a method for operating an image display apparatus, including displaying a broadcast channel list or a menu list on a display, receiving a signal from a remote controller having a touch screen, and scrolling broadcast channel items included in the broadcast channel list or menu items included in the menu list according to information about a touch pattern on the touch screen, included in the received signal. The broadcast channel list or the menu list is changed according to a tap or a drag on the touch screen.

In accordance with another aspect of the present invention, there is provided a method, computer program product and apparatus for operating an image display apparatus configured to be controlled by a wireless remote controller having a touch screen. The method includes: displaying objects on a display of the image display apparatus; and performing an operation on one of the displayed objects by the image display apparatus corresponding to a touch pattern input on the touch screen of the wireless remote controller.

In accordance with another aspect of the present invention, there is provided a method, computer program product and apparatus for controlling an image display apparatus with a wireless remote controller having a touch screen. The method includes: controlling, with the wireless remote controller, the image display apparatus to display objects; and controlling, with the wireless remote controller, an operation on one of the displayed objects by the image display apparatus in response to a touch pattern input on the touch screen of the wireless remote controller.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates the overall configuration of a broadcasting system including an image display apparatus according to an embodiment of the present invention;

FIG. 2 illustrates the overall configuration of a broadcasting system including an image display apparatus according to another embodiment of the present invention;

FIG. 3 is a diagram illustrating a signal flow for an operation for attaching to a Service Provider (SP) and receiving channel information from the SP in the image display apparatus illustrated in FIG. 1 or 2 according to an embodiment of the present invention;

FIG. 4 illustrates an example of data used in the operation illustrated in FIG. 3;

FIG. 5 is a detailed block diagram of the image display apparatus illustrated in FIG. 1 or 2 according to an embodiment of the present invention;

FIG. 6 is a detailed block diagram of the image display apparatus illustrated in FIG. 1 or 2 according to another embodiment of the present invention;

FIGS. 7 and 8 are block diagrams illustrating either of the image display apparatuses separately as a set-top box and a display device according to embodiments of the present invention;

FIG. 9 illustrates an operation for communicating with third devices in either of the image display apparatuses according to an embodiment of the present invention;

FIG. 10 is a block diagram of a controller illustrated in FIG. 6;

FIG. 11 illustrates a platform architecture for either of the image display apparatuses according to an embodiment of the present invention;

FIG. 12 illustrates a platform architecture for either of the image display apparatuses according to another embodiment of the present invention;

FIG. 13 illustrates a method for controlling either of the image display apparatuses in a remote controller according to an embodiment of the present invention;

FIG. 14 is a detailed block diagram of the remote controller in either of the image display apparatuses according to an embodiment of the present invention;

FIG. 15 illustrates a UI in either of the image display apparatuses according to an embodiment of the present invention;

FIG. 16 illustrates a UI in either of the image display apparatuses according to another embodiment of the present invention;

FIG. 17 illustrates a UI in either of the image display apparatuses according to another embodiment of the present invention;

FIG. 18 illustrates a UI in either of the image display apparatuses according to a further embodiment of the present invention;

FIG. 19 is a view referred to for describing methods for operating an image display apparatus according to embodiments of the present invention;

FIG. 20 illustrates the exterior of a remote controller according to an embodiment of the present invention;

FIG. 21 is a block diagram of the remote controller according to an embodiment of the present invention;

FIGS. 22, 23 and 24 are flowcharts illustrating a method for operating the image display apparatus according to an embodiment of the present invention;

FIGS. 25 to 39 are views referred to for describing the method for operating the image display apparatus illustrated in FIGS. 22, 23 and 24;

FIGS. 40 and 41 are flowcharts illustrating a method for operating the remote controller according to an embodiment of the present invention; and

FIGS. 42 to 54 are views referred to for describing the method for operating the remote controller, illustrated in FIGS. 40 and 41.

### DETAILED DESCRIPTION OF THE PREFERRED EMBODIMENTS

Embodiments of the present invention will be described below with reference to the attached drawings.

The terms “module” and “unit” used to signify components are used herein to help the understanding of the components and thus they should not be considered as having specific meanings or roles. Accordingly, the terms “module” and “unit” may be used interchangeably.

An image display apparatus as set forth herein is an intelligent image display apparatus equipped with a computer support function in addition to a broadcast reception function, for example. Thus the image display apparatus may have user-friendly interfaces such as a handwriting input device, a touch screen, or a pointing device. Further, because the image display apparatus supports wired or wireless Internet, it is capable of e-mail transmission/reception, Web browsing, banking, gaming, etc. by connecting to the Internet or a computer. To implement these functions, the image display apparatus may operate based on a standard general-purpose Operating System (OS).

Various applications can be freely added to or deleted from, for example, a general-purpose OS kernel in the image display apparatus according to the present invention. Therefore, the image display apparatus may perform a number of user-friendly functions. The image display apparatus may be a network TV, a Hybrid broadcast broadband TV (HbbTV), a smart TV, etc. for example. The image display apparatus is applicable to a smart phone, as needed.

Embodiments of the present invention will be described in detail with reference to the attached drawings, but it should be understood that they are merely illustrative of the present invention and should not be interpreted as limiting the scope of the present invention.

In addition, although the terms used in the present invention are selected from generally known and used terms, some of the terms mentioned in the description of the present invention, the detailed meanings of which are described in relevant parts of the description herein, have been selected by the applicant at his or her discretion. Furthermore, the present invention must be understood, not simply by the actual terms used but by the meanings of each term lying within.

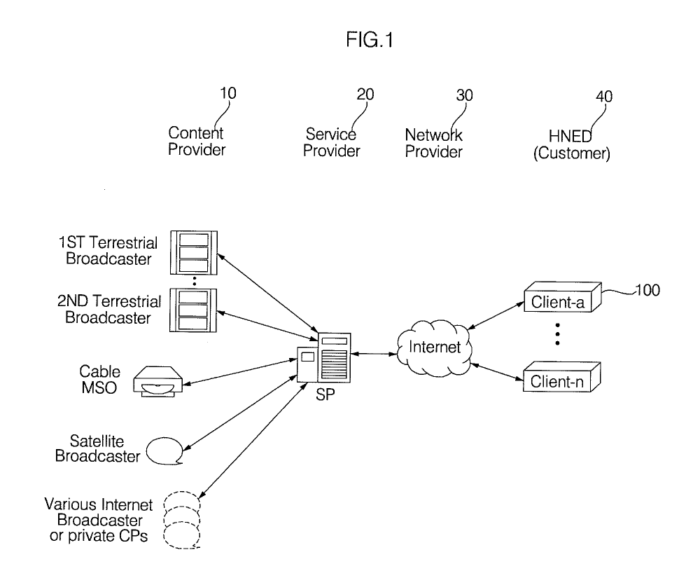

FIG. 1 illustrates the overall configuration of a broadcasting system including an image display apparatus according to an embodiment of the present invention.

Referring to FIG. 1, the broadcasting system may include a Content Provider (CP) 10, a Service Provider (SP) 20, a Network Provider (NP) 30, and a Home Network End Device (HNED) 40. The HNED 40 corresponds to, for example, a client 100 which is an image display apparatus according to an embodiment of the present invention. As stated before, the image display apparatus may be a network TV, a smart TV, an Internet Protocol TV (IPTV), etc.

The CP 10 creates and provides content. The CP 10 may be, for example, a terrestrial broadcaster, a cable System Operator (SO) or Multiple System Operator (MSO), a satellite broadcaster, or an Internet broadcaster, as illustrated in FIG. 1.

Besides broadcast content, the CP 10 may provide various applications, which will be described later in detail.

The SP 20 may provide content received from the CP 10 in a service package. For instance, the SP 20 may package first terrestrial broadcasting, second terrestrial broadcasting, cable broadcasting, satellite broadcasting, Internet broadcasting, and applications and provide the package to users.

The SP 20 may unicast or multicast a service to the client 100. Unicast is a form of transmission in which information is sent from only one transmitter to only one receiver. In other words, unicast transmission is point-to-point, involving two nodes only. In an example of unicast transmission, upon receipt of a request for data from a receiver, a server transmits the data to only one receiver. Multicast is a type of transmission or communication in which a transmitter transmits data to a group of receivers. For example, a server may transmit data to a plurality of pre-registered receivers at one time. For multicast registration, the Internet Group Management Protocol (IGMP) may be used.

The NP 30 may provide a network over which a service is provided to the client 100. The client 100 may construct a home network and receive a service over the home network.

Content transmitted in the above-described broadcasting system may be protected through conditional access or content protection. CableCard and Downloadable Conditional Access System (DCAS) are examples of conditional access or content protection.

The client 100 may also transmit content over a network. In this case, the client 100 serves as a CP and thus the CP 10 may receive content from the client 100. Therefore, an interactive content service or data service can be provided.

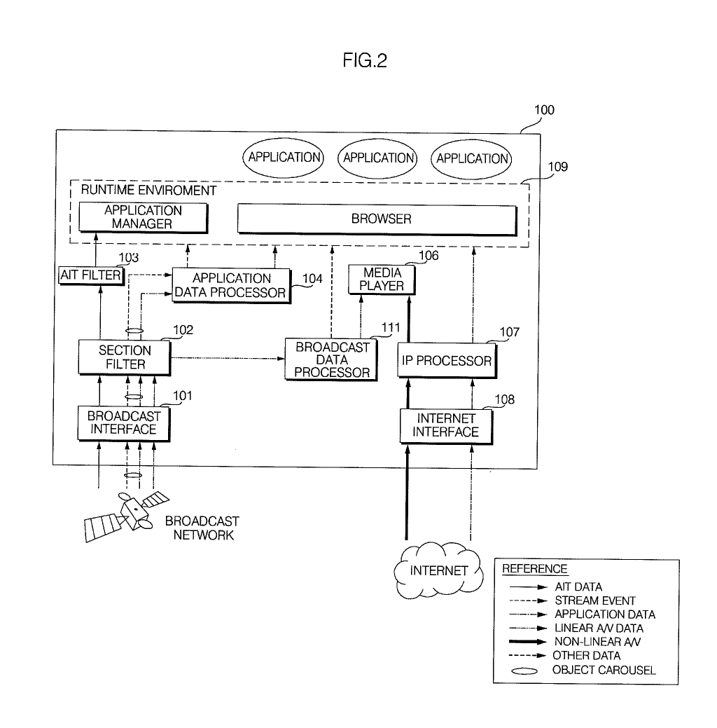

FIG. 2 illustrates the overall configuration of a broadcasting system including an image display apparatus according to another embodiment of the present invention.

Referring to FIG. 2, the image display apparatus 100 according to another embodiment of the present invention is connected to a broadcast network and the Internet. The image display apparatus 100 is, for example, a network TV, a smart TV, an HbbTV, etc.

The image display apparatus 100 includes, for example, a broadcast interface 101, a section filter 102, an Application Information Table (AIT) filter 103, an application data processor 104, a broadcast data processor 111, a media player 106, an IP processor 107, an Internet interface 108, and a runtime module 109.

The image display apparatus 100 receives AIT data, real-time broadcast content, application data, and stream events through the broadcast interface 101. The real-time broadcast content may be referred to as linear Audio/Video (A/V) content.

The section filter 102 performs section filtering on the four types of data received through the broadcast interface 101, and outputs the AIT data to the AIT filter 103, the linear A/V content to the broadcast data processor 111, and the stream events and application data to the application data processor 104.

Meanwhile, the image display apparatus 100 receives non-linear A/V content and application data through the Internet interface 108. The non-linear A/V content may be, for example, a Content On Demand (CoD) application.

The non-linear A/V content and the application data are transmitted to the media player 106 and the runtime module 109, respectively.

The runtime module 109 includes, for example, an application manager and a browser as illustrated in FIG. 2. The application manager controls the life cycle of an interactive application using the AIT data, for example. The browser displays and processes the interactive application.

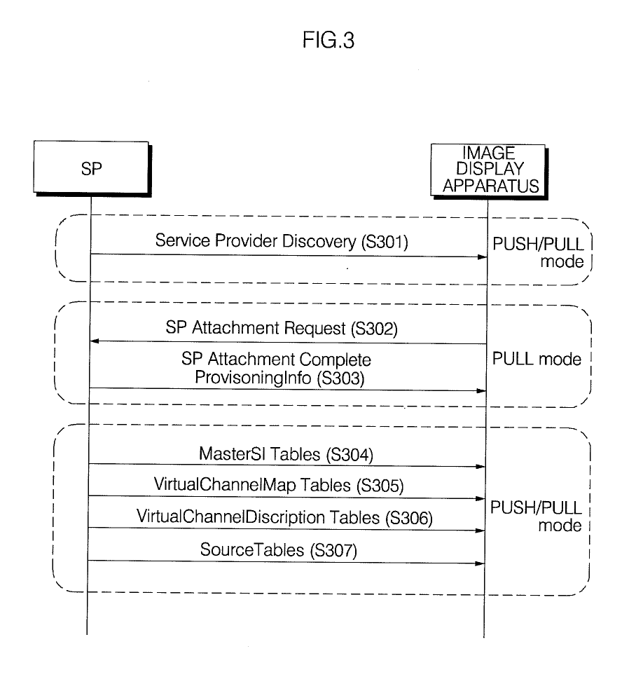

FIG. 3 is a diagram illustrating a signal flow for an operation for attaching to an SP and receiving channel information from the SP in the image display apparatus illustrated in FIG. 1 or 2. Needless to say, the operation illustrated in FIG. 3 is an embodiment, which should not be interpreted as limiting the scope of the present invention.

Referring to FIG. 3, an SP performs an SP Discovery operation (S301) and the image display apparatus transmits a Service Provider Attachment Request signal to the SP (S302). Upon completion of attachment to the SP, the image display apparatus receives provisioning information from the SP (S303). Further, the image display apparatus receives Master System Information (SI) Tables, Virtual Channel Map Tables, Virtual Channel Description Tables, and Source Tables from the SP (S304 to S307).

More specifically, SP Discovery is a process by which SPs that provide IPTV services search for Service Discovery (SD) servers having information about the offerings of the SPs.

In order to receive information about the SD servers, an SD server address list can be detected, for example, using three methods, specifically use of an address preset in the image display apparatus or an address manually set by a user, Dynamic Host Configuration Protocol (DHCP)-based SP Discovery, and Domain Name System Service (DNS SRV)-based SP Discovery. The image display apparatus accesses a specific SD server using the SD server address list obtained through one of the above three methods and receives a SP Discovery record from the specific SD server. The Service Provider Discovery record includes information needed to perform Service Discovery on an SP basis. The image display apparatus then starts a Service Discovery operation using the SP Discovery record. These operations can be performed in a push mode or a pull mode.

The image display apparatus accesses an SP attachment server specified by an SP attachment locator included in the SP Discovery record and performs a registration procedure (or a service attachment procedure).

Further, after accessing an authentication service server of an SP specified by an SP authentication locator and performing an authentication procedure, the image display apparatus may perform a service authentication procedure.

After service attachment is successfully performed, a server may transmit data in the form of a provision information table to the image display apparatus.

During service attachment, the image display apparatus may include an Identifier (ID) and location information thereof in data and transmit the data to the service attachment server. Thus the service attachment server may specify a service that the image display apparatus has subscribed to based on the ID and location information. In addition, the service attachment server provides, in the form of a provisioning information table, address information from which the image display apparatus can obtain Service Information (SI). The address information corresponds to access information about a Master SI Table. This method facilitates provision of a customized service to each subscriber.

The SI is divided into a Master SI Table record for managing access information and version information about a Virtual Channel Map, a Virtual Channel Map Table for providing a list of services in the form of a package, a Virtual Channel Description Table that contains details of each channel, and a Source Table that contains access information about actual services.

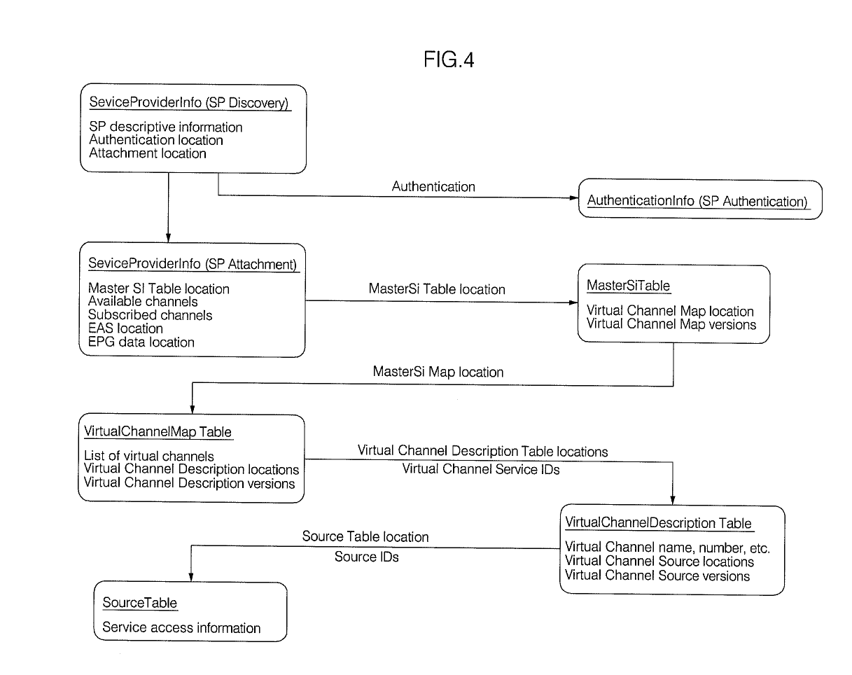

FIG. 4 is a detailed diagram of FIG. 3, illustrating a relationship among data in the SI.

Referring to FIG. 4, a Master SI Table contains information about the location and version of each Virtual Channel MAP.

Each Virtual Channel MAP is identified by its Virtual Channel MAP identifier. VirtualChannelMAPVersion specifies the version number of the Virtual Channel MAP. If any of the tables connected to the Master SI Table in the arrowed direction is modified, the versions of the modified table and overlying tables thereof (up to the Master SI Table) are incremented. Accordingly, a change in any of the SI tables can be readily identified by monitoring the Master SI Table.

For example, when the Source Table is changed, the version of the Source Table is incremented and the version of the Virtual Channel Description Table that references the Source Table is also incremented. In conclusion, a change in any lower table leads to a change in its higher tables and, eventually, a change in the Master SI Table.

One Master SI Table may exist for each SP. However, in the case where service configurations differ for regions or subscribers (or subscriber groups), an SP may have a plurality of Master SI Tables in order to provide a customized service on a region, subscriber or subscriber group basis. Thus it is possible to provide a customized service to a subscriber according to a region in which the subscriber is located and subscriber information regarding the subscriber.

A Virtual Channel Map Table may contain a list of one or more virtual channels. A Virtual Channel Map includes not details of the channels but information about the locations of the details of the channels. In the Virtual Channel Map Table, VirtualChannelDescriptionLocation specifies the location of a Virtual Channel Description Table that provides virtual channel descriptions.

The Virtual Channel Description Table contains the details of the virtual channels. The Virtual Channel Description Table can be accessed using VirtualChannelDescriptionLocation of the Virtual Channel Map Table.

A Source Table provides information necessary to access actual services (e.g. IP addresses, ports, AV Codecs, transmission protocols, etc.) on a service basis.

The above-described Master SI Table, the Virtual Channel Map Table, the Virtual Channel Description Table and the Source Table are delivered in four logically separate flows, in a push mode or a pull mode. For version management, the Master SI Table may be multicast and thus a version change can be monitored by receiving a multicast stream of the Master SI Table.

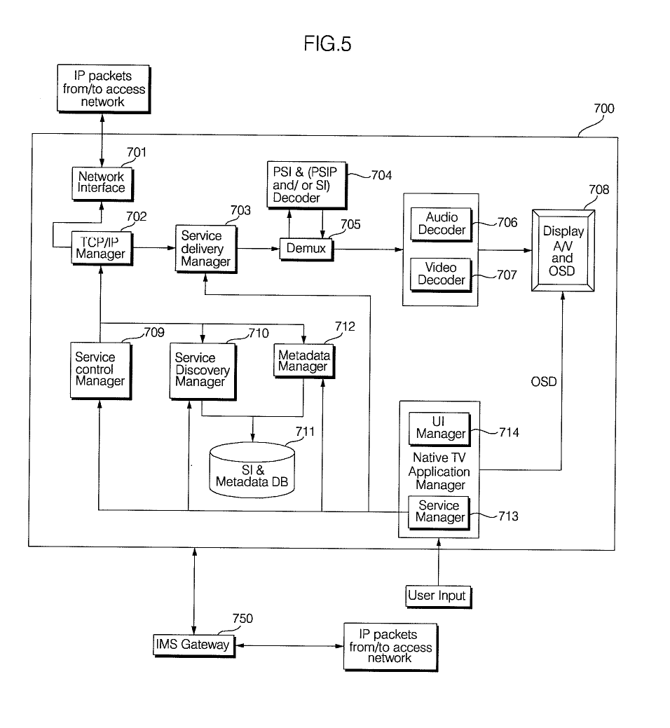

FIG. 5 is a detailed block diagram of the image display apparatus illustrated in FIG. 1 or 2 according to an embodiment of the present invention. The structure of the image display apparatus in FIG. 5 is purely exemplary and should not be interpreted as limiting the scope of the present invention.

Referring to FIG. 5, an image display apparatus 700 includes a network interface 701, a Transmission Control Protocol/Internet Protocol (TCP/IP) manager 702, a service delivery manager 703, a Demultiplexer (DEMUX) 705, a Program Specific Information (PSI) & (Program and System Information Protocol (PST) and/or SI) decoder 704, a display A/V and On Screen Display (OSD) module 708, a service control manager 709, a service discovery manager 710, a metadata manager 712, an SI & metadata DataBase (DB) 711, a User Interface (UI) manager 714, and a service manager 713.

The network interface 701 transmits packets to and receives packets from a network. Specifically, the network interface 701 receives services and content from an SP over the network.

The TCP/IP manager 702 is involved in packet reception and transmission of the image display apparatus 700, that is, packet delivery from a source to a destination. The TCP/IP manager 702 classifies received packets according to appropriate protocols and outputs the classified packets to the service delivery manager 705, the service discovery manager 710, the service control manager 709, and the metadata manager 712.

The service delivery manager 703 controls received service data. For example, when controlling real-time streaming data, the service delivery manager 703 may use the Real-time Transport Protocol/Real-time Transport Control Protocol (RTP/RTCP). If real-time streaming data is transmitted over RTP/RTCP, the service delivery manager 703 parses the received real-time streaming data using RTP and outputs the parsed real-time streaming data to the DEMUX 705 or stores the parsed real-time streaming data in the SI & metadata DB 711 under the control of the service manager 713. In addition, the service delivery manager 703 feeds back network reception information to a server that provides the real-time streaming data service using RTCP.

The DEMUX 705 demultiplexes a received packet into audio data, video data and PSI data and outputs the audio data, video data and PSI data to the audio decoder 706, the video decoder 707, and the PSI & (PSIP and/or SI) decoder 704, respectively.

The PSI & (PSIP and/or SI) decoder 704 decodes SI such as PSI. More specifically, the PSI & (PSIP and/or SI) decoder 704 decodes PSI sections, PSIP sections or SI sections received from the DEMUX 705.

The PSI & (PSIP and/or SI) decoder 704 constructs an SI DB by decoding the received sections and stores the SI DB in the SI & metadata DB 711.

The audio decoder 706 and the video decoder 707 decode the audio data and the video data received from the DEMUX 705 and output the decoded audio and video data to a user through the display A/V and OSD module 708.

The UI manager 714 and the service manager 713 manage the overall state of the image display apparatus 700, provide UIs, and manage other managers.

The UI manager 714 provides a Graphical User Interface (GUI) in the form of an OSD and performs a reception operation corresponding to a key input received from the user. For example, upon receipt of a key input signal regarding channel selection from the user, the UI manager 714 transmits the key input signal to the service manager 713.

The service manager 713 controls managers associated with services, such as the service delivery manager 703, the service discovery manager 710, the service control manager 709, and the metadata manager 712.

The service manager 713 also makes a channel map and selects a channel using the channel map according to the key input signal received from the UI manager 714. The service manager 713 sets the audio/video Packet ID (PID) of the selected channel based on SI about the channel received from the PSI & (PSIP and/or SI) decoder 704.

The service discovery manager 710 provides information necessary to select an SP that provides a service. Upon receipt of a channel selection signal from the service manager 713, the service discovery manager 710 detects a service based on the channel selection signal.

The service control manager 709 takes charge of selecting and control services. For example, if a user selects live broadcasting, like a conventional broadcasting service, the service control manager selects and controls the service using Internet Group Management Protocol (IGMP) or Real-Time Streaming Protocol (RTSP). If the user selects Video on Demand (VoD), the service control manager 709 selects and controls the service. RTSP supports trick mode for real-time streaming. Further, the service control manager 709 may initialize and manage a session through an IP Multimedia Control (IMC) gateway using IP Multimedia Subsystem (IMS) and Session Initiation Protocol (SIP). The protocols are given by way of example and thus other protocols are also applicable according to other embodiments.

The metadata manager 712 manages metadata related to services and stores the metadata in the SI & metadata DB 711.

The SI & metadata DB 711 stores the SI decoded by the PSI & (PSIP and/or SI) decoder 704, the metadata managed by the metadata manager 712, and the information required to select an SP, received from the service discovery manager 710. The SI & metadata DB 711 may store setup data for the system.

The SI & metadata DB 711 may be constructed in a Non-Volatile RAM (NVRAM) or a flash memory.

An IMS gateway 705 is a gateway equipped with functions needed to access IMS-based IPTV services.

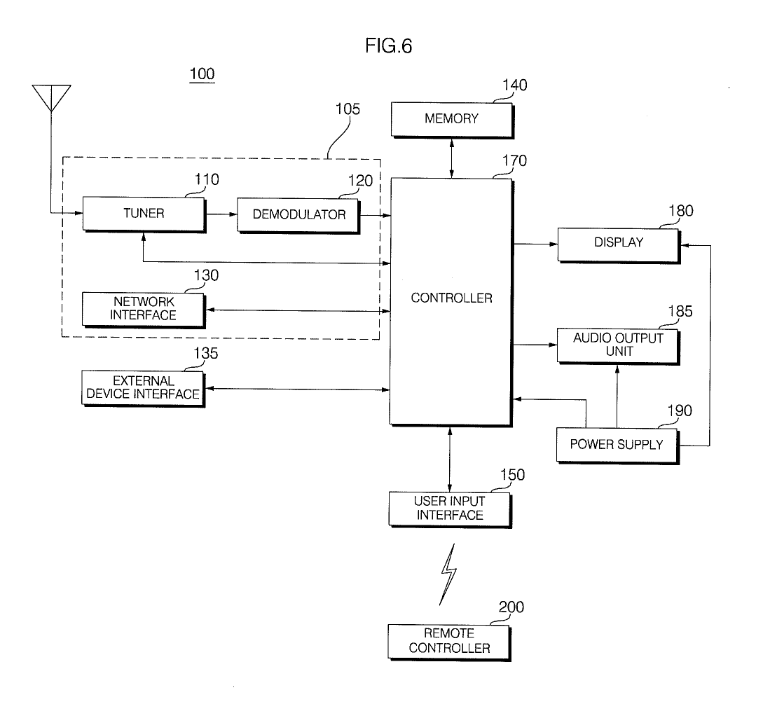

FIG. 6 is a detailed block diagram of the image display apparatus illustrated in FIG. 1 or 2 according to another embodiment of the present invention.

Referring to FIG. 6, an image display apparatus 100 according to another embodiment of the present invention includes a broadcasting receiver 105, an external device interface 135, a memory 140, a user input interface 150, a controller 170, a display 180, an audio output unit 185, a power supply 190, and a camera module. The broadcasting receiver 105 may include a tuner 110, a demodulator 120 and a network interface 130. As needed, the broadcasting receiver 105 may be configured so as to include only the tuner 110 and the demodulator 120 or only the network interface 130.

The tuner 110 selects a Radio Frequency (RF) broadcast signal corresponding to a channel selected by a user from among a plurality of RF broadcast signals received through an antenna and downconverts the selected RF broadcast signal into a digital Intermediate Frequency (IF) signal or an analog baseband A/V signal.

More specifically, if the selected RF broadcast signal is a digital broadcast signal, the tuner 110 downconverts the selected RF broadcast signal into a digital IF signal DIF. On the other hand, if the selected RF broadcast signal is an analog broadcast signal, the tuner 110 downconverts the selected RF broadcast signal into an analog baseband A/V signal, CVBS/SIF. That is, the tuner 110 may be a hybrid tuner capable of processing not only digital broadcast signals but also analog broadcast signals. The analog baseband A/V signal CVBS/SIF may be directly input to the controller 170.

The tuner 110 may be capable of receiving RF broadcast signals from an Advanced Television Systems Committee (ATSC) single-carrier system or from a Digital Video Broadcasting (DVB) multi-carrier system.

The tuner 110 may sequentially select a number of RF broadcast signals corresponding to all broadcast channels previously stored in the image display apparatus 100 by a channel add function from a plurality of RF signals received through the antenna and may downconvert the selected RF broadcast signals into IF signals or baseband A/V signals.

The demodulator 120 receives the digital IF signal DIF from the tuner 110 and demodulates the digital IF signal DIF.

For example, if the digital IF signal DIF is an ATSC signal, the demodulator 120 may perform 8-Vestigal SideBand (VSB) demodulation on the digital IF signal DIF. The demodulator 120 may also perform channel decoding. For channel decoding, the demodulator 120 may include a Trellis decoder, a de-interleaver and a Reed-Solomon decoder so as to perform Trellis decoding, de-interleaving and Reed-Solomon decoding.

For example, if the digital IF signal DIF is a DVB signal, the demodulator 120 performs Coded Orthogonal Frequency Division Multiple Access (COFDMA) demodulation upon the digital IF signal DIF. The demodulator 120 may also perform channel decoding. For channel decoding, the demodulator 120 may include a convolution decoder, a de-interleaver, and a Reed-Solomon decoder so as to perform convolution decoding, de-interleaving, and Reed-Solomon decoding.

The demodulator 120 may perform demodulation and channel decoding on the digital IF signal DIF, thereby obtaining a stream signal TS. The stream signal TS may be a signal in which a video signal, an audio signal and a data signal are multiplexed. For example, the stream signal TS may be an MPEG-2 TS in which an MPEG-2 video signal and a Dolby AC-3 audio signal are multiplexed. An MPEG-2 TS may include a 4-byte header and a 184-byte payload.

In order to properly handle not only ATSC signals but also DVB signals, the demodulator 120 may include an ATSC demodulator and a DVB demodulator.

The stream signal TS may be input to the controller 170 and thus subjected to demultiplexing and A/V signal processing. The processed video and audio signals are output to the display 180 and the audio output unit 185, respectively.

The external device interface 135 may serve as an interface between an external device and the image display apparatus 100. For interfacing, the external device interface 135 may include an A/V Input/Output (I/O) unit and/or a wireless communication module.

The external device interface 135 may be connected to an external device such as a Digital Versatile Disk (DVD) player, a Blu-ray player, a game console, a camera, a camcorder, or a computer (e.g., a laptop computer), wirelessly or by wire. Then, the external device interface 135 externally receives video, audio, and/or data signals from the external device and transmits the received input signals to the controller 170. In addition, the external device interface 135 may output video, audio, and data signals processed by the controller 170 to the external device. In order to receive or transmit audio, video and data signals from or to the external device, the external device interface 135 includes the A/V I/O unit and/or the wireless communication module.

The A/V I/O unit of the external device interface 135 may include a Universal Serial Bus (USB) port, a Composite Video Banking Sync (CVBS) port, a Component port, a Super-video (S-video) (analog) port, a Digital Visual Interface (DVI) port, a High-Definition Multimedia Interface (HDMI) port, a Red-Green-Blue (RGB) port, and a D-sub port.

The wireless communication module of the external device interface 135 may perform short-range wireless communication with other electronic devices. For short-range wireless communication, the wireless communication module may use Bluetooth, Radio-Frequency IDentification (RFID), Infrared Data Association (IrDA), Ultra WideBand (UWB), ZigBee, and Digital Living Network Alliance (DLNA).

The external device interface 135 may be connected to various set-top boxes through at least one of the above-described ports and may thus receive data from or transmit data to the various set-top boxes.

The external device interface 135 may receive applications or an application list from an adjacent external device and provide the applications or the application list to the controller 170 or the memory 140.

The network interface 130 serves as an interface between the image display apparatus 100 and a wired/wireless network such as the Internet. The network interface 130 may include an Ethernet port for connection to a wired network. The wireless communication module of the external signal I/O unit 128 may wirelessly access the Internet. For connection to wireless networks, the network interface 130 may use Wireless Local Area Network (WLAN) (i.e., Wi-Fi), Wireless Broadband (WiBro), World Interoperability for Microwave Access (WiMax), and High Speed Downlink Packet Access (HSDPA).

The network interface 130 may transmit data to or receive data from another user or electronic device over a connected network or another network linked to the connected network. Especially, the network interface 130 may transmit data stored in the image display apparatus 100 to a user or electronic device selected from among users or electronic devices pre-registered with the image display apparatus 100.

The network interface 130 may access a specific Web page over a connected network or another network linked to the connected network. That is, the network interface 130 may access a specific Web page over a network and transmit or receive data to or from a server. Additionally, the network interface 130 may receive content or data from a CP or an NP. Specifically, the network interface 130 may receive content such as movies, advertisements, games, VoD files, and broadcast signals, and information related to the content from a CP or an NP. Also, the network interface 130 may receive update information about firmware and update files of the firmware from the NP. The network interface 130 may transmit data over the Internet or to the CP or the NP.

The network interface 130 may selectively receive a desired application among open applications over a network.

In an embodiment of the present invention, when a game application is executed in the image display apparatus 100, the network interface 130 may transmit data to or receive data from a user terminal connected to the image display apparatus 100 through a network. In addition, the network interface 130 may transmit specific data to or receive specific data from a server that records game scores.

The memory 140 may store various programs necessary for the controller 170 to process and control signals, and may also store processed video, audio and data signals.

The memory 140 may temporarily store a video, audio and/or data signal received from the external device interface 135 or the network interface 130. The memory 140 may store information about broadcast channels by the channel-add function.

The memory 140 may store applications or a list of applications received from the external device interface 135 or the network interface 130.

The memory 140 may store a variety of platforms which will be described later.

In an embodiment of the present invention, when the image display apparatus 100 executes a game application, the memory 140 may store user-specific information and game play information about a user terminal used as a game controller.

The memory 140 may include, for example, at least one of a flash memory-type storage medium, a hard disk-type storage medium, a multimedia card micro-type storage medium, a card-type memory (e.g. a Secure Digital (SD) or eXtreme Digital (XD) memory), a Random Access Memory (RAM), or a Read-Only Memory (ROM) such as an Electrically Erasable and Programmable Read Only Memory. The image display apparatus 100 may reproduce content stored in the memory 140 (e.g. video files, still image files, music files, text files, and application files) to the user.

While the memory 140 is shown in FIG. 6 as configured separately from the controller 170, to which the present invention is not limited, the memory 140 may be incorporated into the controller 170, for example.

The user input interface 150 transmits a signal received from the user to the controller 170 or transmits a signal received from the controller 170 to the user.

For example, the user input interface 150 may receive various user input signals such as a power-on/off signal, a channel selection signal, and a screen setting signal from a remote controller 200 or may transmit a signal received from the controller 170 to the remote controller 200, according to various communication schemes, for example, RF communication and IR communication.

For example, the user input interface 150 may provide the controller 170 with user input signals or control signals received from local keys, such as inputs of a power key, a channel key, and a volume key, and setting values.

Also, the user input interface 150 may transmit a control signal received from a sensor unit for sensing a user gesture to the controller 170 or transmit a signal received from the controller 170 to the sensor unit. The sensor unit may include a touch sensor, a voice sensor, a position sensor, a motion sensor, etc.

The controller 170 may demultiplex the stream signal TS received from the tuner 110, the demodulator 120, or the external device interface 135 into a number of signals and process the demultiplexed signals into audio and video data.

The video signal processed by the controller 170 may be displayed as an image on the display 180. The video signal processed by the controller 170 may also be transmitted to an external output device through the external device interface 135.

The audio signal processed by the controller 170 may be output to the audio output unit 185. Also, the audio signal processed by the controller 170 may be transmitted to the external output device through the external device interface 135.

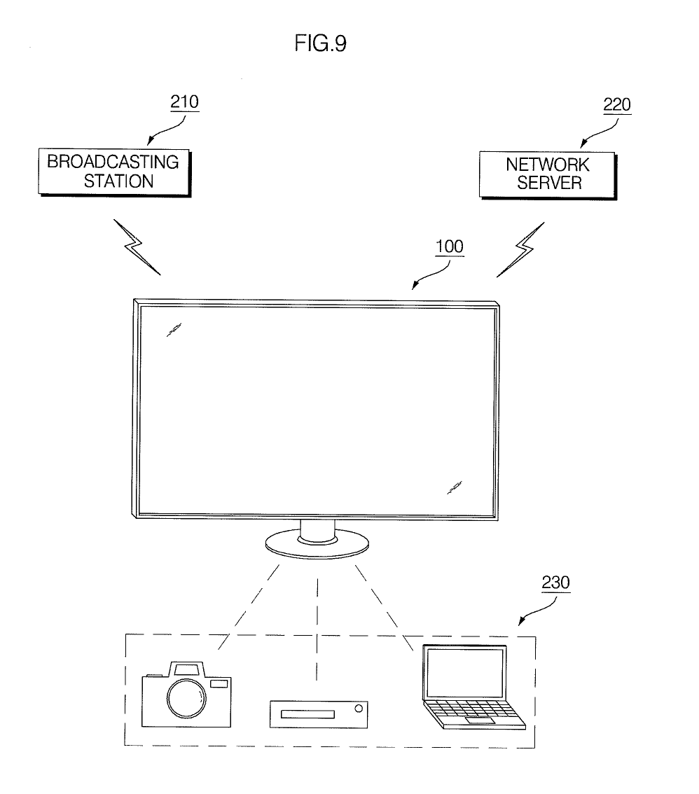

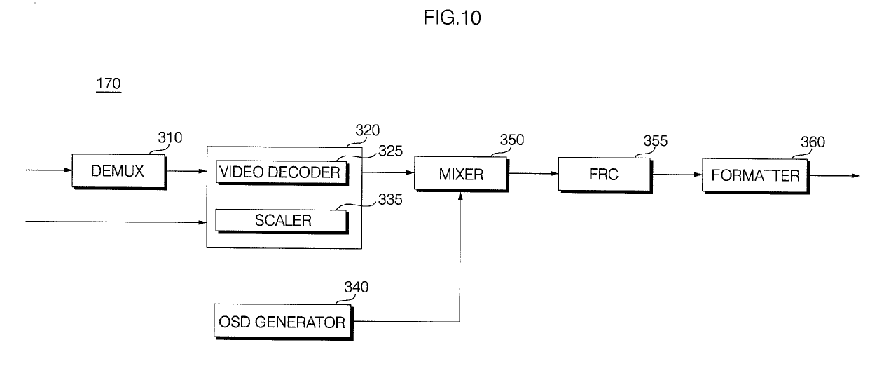

While not shown in FIG. 6, the controller 170 may include a DEMUX and a video processor, which will be described later with reference to FIG. 10.

In addition, the controller 170 may provide overall control to the image display apparatus 100. For example, the controller 170 may control the tuner 110 to select an RF broadcast signal corresponding to a user-selected channel or a pre-stored channel.

The controller 170 may control the image display apparatus 100 according to a user command received through the user input interface 150 or according to an internal program. Especially the controller 170 may access a network and download an application or application list selected by the user to the image display apparatus 100 over the network.

For example, the controller 170 controls the tuner 110 to receive a channel selected according to a specific channel selection command received through the user input interface 150 and processes a video, audio and/or data signal of the selected channel. The controller 170 outputs the processed video or audio signal along with information about the user-selected channel to the display 180 or the audio output unit 185.

In another example, the controller 170 outputs a video or audio signal received from an external device such as a camera or a camcorder through the external device interface 135 to the display 180 or the audio output unit 185 according to an external device video playback command received through the external device interface 150.

The controller 170 may control the display 180 to display images. For instance, the controller 170 may control the display 180 to display a broadcast image received from the tuner 110, an external input image received through the external device interface 135, an image received through the network interface 130, or an image stored in the memory 140. The image displayed on the display 180 may be a Two-Dimensional (2D) or Three-Dimensional (3D) still image or moving picture.

The controller 170 may control content playback. The content may include any content stored in the image display apparatus 100, received broadcast content, and external input content. The content includes at least one of a broadcast image, an external input image, an audio file, a still image, a Web page, or a text file.

Upon receipt of a go-to-home screen input, the controller 170 may control display of the home screen on the display 180 in an embodiment of the present invention.

The home screen may include a plurality of card objects classified according to content sources. The card objects may include at least one of a card object representing a thumbnail list of broadcast channels, a card object representing a broadcast program guide, a card object representing a program reservation list or a program recording list, or a card object representing a media list of a device connected to the image display apparatus 100. The card objects may further include at least one of a card object representing a list of connected external devices or a card object representing a call-associated list.

The home screen may further include an application menu with at least one application that can be executed.

Upon receipt of a card object move input, the controller 170 may control movement of a card object corresponding to the card object move input on the display 180, or if the card object is not displayed on the display 180, the controller 170 may control display of the card object on the display 180.

When a card object is selected from among the card objects on the home screen, the controller 170 may control display of an image corresponding to the selected card object on the display 180.

The controller 170 may control display of an input broadcast image and an object representing information about the broadcast image in a card object representing broadcast images. The broadcast image may be fixed in size through lock setting.

The controller 170 may control display of a set-up object for at least one of image setting, audio setting, screen setting, reservation setting, setting of a pointer of the remote controller, or network setting on the home screen.

The controller 170 may control display of a log-in object, a help object, or an exit object on a part of the home screen.

The controller 170 may control display of an object representing the total number of available card objects or the number of card objects displayed on the display 180 among all card objects, on a part of the home screen.

If one of the card objects displayed on the display 180 is selected, the controller 170 may fuliscreen the selected card object to cover the entirety of the display 180.

Upon receipt of an incoming call at a connected external device or the image display apparatus 100, the controller 170 may control focusing-on or shift of a call-related card object among the plurality of card objects.

If an application view menu item is selected, the controller 170 may control display of applications or a list of applications that are available in the image display apparatus or downloadable from an external network.

The controller 170 may control installation and execution of an application downloaded from the external network along with various UIs. Also, the controller 170 may control display of an image related to the executed application on the display 180, upon user selection.

In an embodiment of the present invention, when the image display apparatus 100 provides a game application, the controller 170 may control assignment of player IDs to specific user terminals, creation of game play information by executing the game application, transmission of the game play information to the user terminals through the network interface 130, and reception of the game play information at the user terminals.

The controller 170 may control detection of user terminals connected to the image display apparatus 100 over a network through the network interface 130, display of a list of the detected user terminals on the display 180 and reception of a selection signal indicating a user terminal selected for use as a user controller from among the listed user terminals through the user input interface 150.

The controller 170 may control output of a game play screen of the game application, inclusive of player information about each user terminal and game play information, through the display 180.

The controller 170 may determine the specific signal received from a user terminal through the network interface 130 as game play information and thus control the game play information to be reflected in the game application in progress.

The controller 170 may control transmission of the game play information about the game application to a specific server connected to the image display apparatus 100 over a network through the network interface 130.

As another embodiment, upon receipt of information about a change in the game play information from the server through the network interface 130, the controller 170 may control output of a notification message in a predetermined area of the display 180.

The image display apparatus 100 may further include a channel browsing processor for generating thumbnail images corresponding to channel signals or external input signals.

The channel browsing processor may extract some of the video frames of each of stream signals TS received from the demodulator 120 or stream signals received from the external device interface 135 and display the extracted video frames on the display 180 as thumbnail images. The thumbnail images may be directly output to the controller 170 or may be output after being encoded. Also, it is possible to encode the thumbnail images into a stream and output the stream to the controller 170. The controller 170 may display a thumbnail list including a plurality of received thumbnail images on the display 180. The thumbnail images may be updated sequentially or simultaneously in the thumbnail list. Therefore, the user can readily identify the content of broadcast programs received through a plurality of channels.

The display 180 may convert a processed video signal, a processed data signal, and an OSD signal received from the controller 170 or a video signal and a data signal received from the external device interface 135 into RGB signals, thereby generating driving signals.

The display 180 may be various types of displays such as a Plasma Display Panel (PDP), a Liquid Crystal Display (LCD), an Organic Light-Emitting Diode (OLED) display, a flexible display, and a 3D display.

The display 180 may also be a touch screen that can be used not only as an output device but also as an input device.

The audio output unit 185 may receive a processed audio signal (e.g., a stereo signal, a 3.1-channel signal or a 5.1-channel signal) from the controller 170 and output the received audio signal as sound. The audio output unit 185 may employ various speaker configurations.

To sense a user gesture, the image display apparatus 100 may further include the sensor unit that has at least one of a touch sensor, a voice sensor, a position sensor, and a motion sensor, as stated before. A signal sensed by the sensor unit may be output to the controller 170 through the user input interface 150.

The image display apparatus 100 may further include the camera unit for capturing images of a user. Image information captured by the camera unit may be input to the controller 170.

The controller 170 may sense a user gesture from an image captured by the camera unit or a signal sensed by the sensor unit, or by combining the captured image and the sensed signal.

The power supply 190 supplies power to the image display apparatus 100. Particularly, the power supply 190 may supply power to the controller 170, the display 180, and the audio output unit 185, which may be implemented as a System On Chip (SOC).

For supplying power, the power supply 190 may include a converter for converting Alternating Current (AC) into Direct Current (DC). If the display 180 is configured with, for example, a liquid crystal panel having a plurality of backlight lamps, the power supply 190 may further include an inverter capable of performing Pulse Width Modulation (PWM) for luminance change or dimming driving.

The remote controller 200 transmits a user input to the user input interface 150. For transmission of user input, the remote controller 200 may use various communication techniques such as Bluetooth, RF communication, IR communication, UWB and ZigBee.

In addition, the remote controller 200 may receive a video signal, an audio signal or a data signal from the user input interface 150 and output the received signals visually, audibly or as vibrations.

The above-described image display apparatus 100 may be a fixed digital broadcast receiver capable of receiving at least one of ATSC (8-VSB) broadcast programs, DVB-T (COFDM) broadcast programs, and ISDB-T (BST-OFDM) broadcast programs.

The block diagram of the image display apparatus 100 illustrated in FIG. 6 is purely exemplary. Depending upon the specifications of the image display apparatus 100 in actual implementation, the components of the image display apparatus 100 may be combined or omitted or new components may be added. That is, two or more components are incorporated into one component or one component may be configured as separate components, as needed. In addition, the function of each block is described for the purpose of describing the embodiment of the present invention and thus specific operations or devices should not be construed as limiting the scope and spirit of the present invention.

Unlike the configuration illustrated in FIG. 6, the image display apparatus 100 may be configured so as to receive and playback video content through the network interface 130 or the external device interface 135, without the tuner 100 and the demodulator 120.

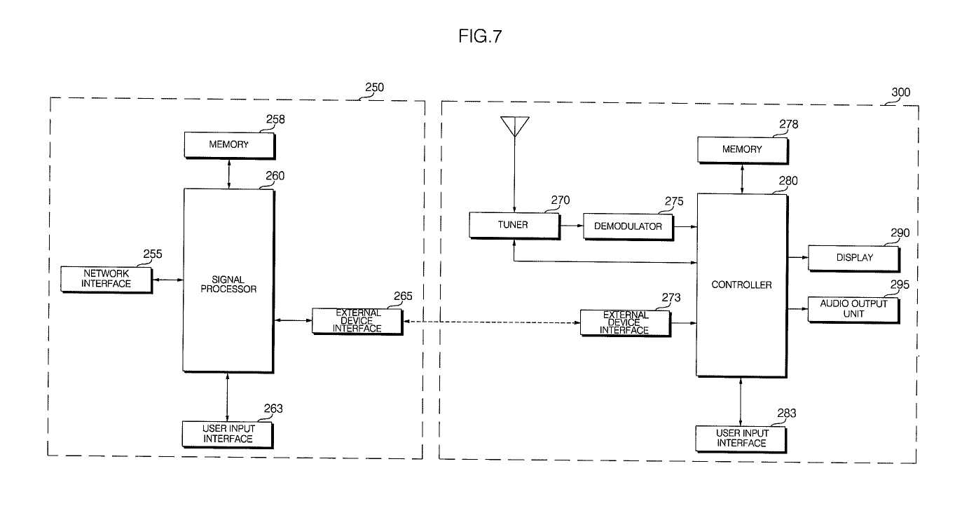

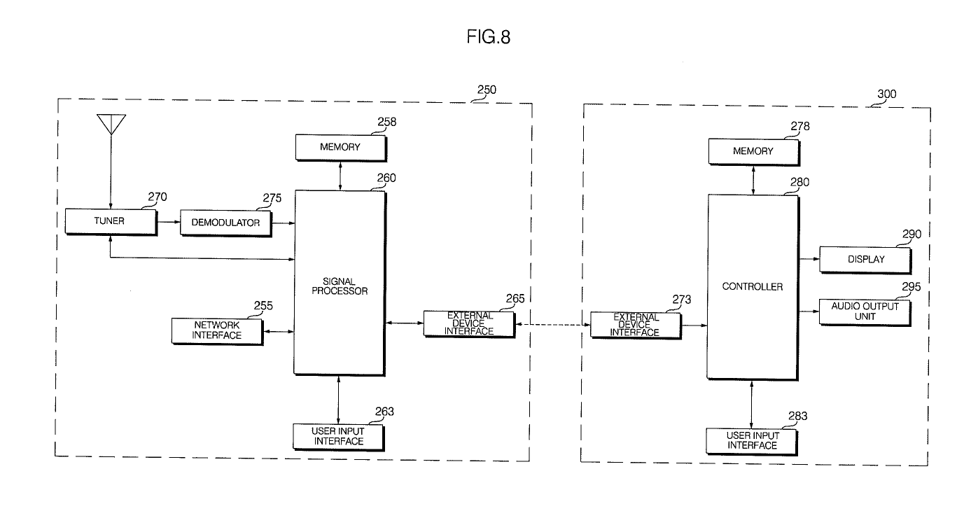

The image display apparatus 100 is an example of image signal processing apparatus that processes a stored image or an input image. Other examples of the image signal processing apparatus include a set-top box without the display 180 and the audio output unit 185, a DVD player, a Blu-ray player, a game console, and a computer. The set-top box will be described later with reference to FIGS. 7 and 8.

FIGS. 7 and 8 are block diagrams illustrating either of the image display apparatuses separately as a set-top box and a display device according to embodiments of the present invention.

Referring to FIG. 7, a set-top box 250 and a display device 300 may transmit or receive data wirelessly or by wire.

The set-top box 250 may include a network interface 255, a memory 258, a signal processor 260, a user input interface 263, and an external device interface 265.

The network interface 255 serves as an interface between the set-top box 250 and a wired/wireless network such as the Internet. The network interface 255 may transmit data to or receive data from another user or another electronic device over a connected network or over another network linked to the connected network.

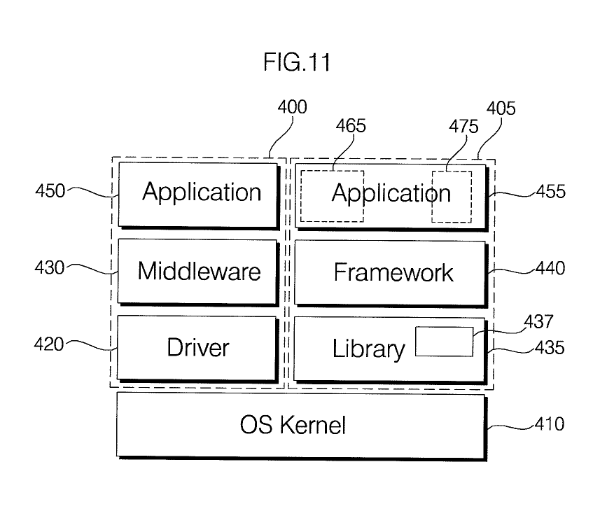

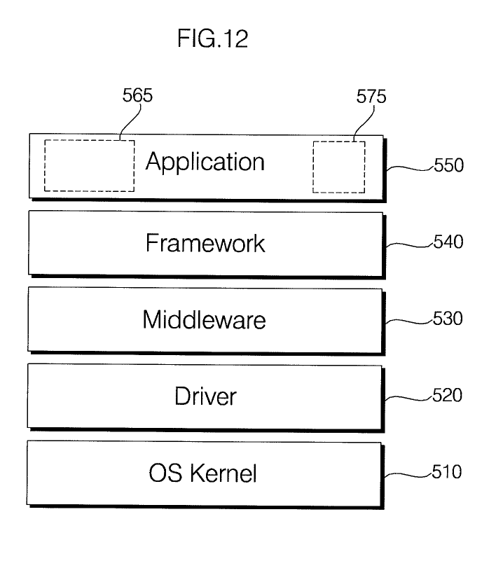

The memory 258 may store programs necessary for the signal processor 260 to process and control signals and temporarily store a video, audio and/or data signal received from the external device interface 265 or the network interface 255. The memory 258 may also store platforms illustrated in FIGS. 11 and 12, as described later.

The signal processor 260 processes an input signal. For example, the signal processor 260 may demultiplex or decode an input video or audio signal. For signal processing, the signal processor 260 may include a video decoder or an audio decoder. The processed video or audio signal may be transmitted to the display device 300 through the external device interface 265.

The user input interface 263 transmits a signal received from the user to the signal processor 260 or a signal received from the signal processor 260 to the user. For example, the user input interface 263 may receive various control signals such as a power on/off signal, an operation input signal, and a setting input signal through a local key or the remote controller 200 and output the control signals to the signal processor 260.

The external device interface 265 serves as an interface between the set-top box 250 and an external device that is connected wirelessly or by wire, particularly the display device 300, for signal transmission or reception. The external device interface 265 may also interface with an external device such as a game console, a camera, a camcorder, and a computer (e.g. a laptop computer), for data transmission or reception.

The set-top box 250 may further include a media input unit for media playback. The media input unit may be a Blu-ray input unit, for example. That is, the set-top box 250 may include a Blu-ray player. After signal processing such as demultiplexing or decoding in the signal processor 260, a media signal from a Blu-ray disk may be transmitted to the display device 300 through the external device interface 265 so as to be displayed on the display device 300.

The display device 300 may include a tuner 270, an external device interface 273, a demodulator 275, a memory 278, a controller 280, a user input interface 283, a display 290, and an audio output unit 295.

The tuner 270, the demodulator 275, the memory 278, the controller 280, the user input interface 283, the display 290, and the audio output unit 295 are identical respectively to the tuner 110, the demodulator 120, the memory 140, the controller 170, the user input interface 150, the display 180, and the audio output unit 185 illustrated in FIG. 6 and thus a description thereof is not provided herein.

The external device interface 273 serves as an interface between the display device 300 and a wireless or wired external device, particularly the set-top box 250, for data transmission or reception.

Hence, a video signal or an audio signal received through the set-top box 250 is output through the display 290 or the audio output unit 295 through the controller 280.

Referring to FIG. 8, the configuration of the set-top box 250 and the display device 300 illustrated in FIG. 8 is similar to that of the set-top box 250 and the display device 300 illustrated in FIG. 7, except that the tuner 270 and the demodulator 275 reside in the set-top box 250, not in the display device 300. Thus the following description is given focusing on such difference.

The signal processor 260 may process a broadcast signal received through the tuner 270 and the demodulator 275. The user input interface 263 may receive a channel selection input, a channel store input, etc.

FIG. 9 illustrates an operation for communicating with third devices in either of the image display apparatuses according to an embodiment of the present invention. The image display apparatus illustrated in FIG. 9 may be one of the afore-described image display apparatuses according to the embodiments of the present invention.

Referring to FIG. 9, the image display apparatus 100 may communicate with a broadcasting station 210, a network server 220, or an external device 230.

The image display apparatus 100 may receive a broadcast signal including a video signal from the broadcasting station 210. The image display apparatus 100 may process the audio and video signals of the broadcast signal or the data signal of the broadcast signal, suitably for transmission from the image display apparatus 100. The image display apparatus 100 may output images or sound based on the processed video or audio signal.

Meanwhile, the image display apparatus 100 may communicate with the network server 220. The network server 200 is capable of transmitting signals to and receiving signals from the image display apparatus 100 over a network. For example, the network server 220 may be a portable terminal that can be connected to the image display apparatus 100 through a wired or wireless base station. In addition, the network server 200 may provide content to the image display apparatus 100 over the Internet. A CP may provide content to the image display apparatus 100 through the network server 220.

The image display apparatus 100 may communicate with the external device 230. The external device 230 can transmit and receive signals directly to and from the image display apparatus 100 wirelessly or by wire. For instance, the external device 230 may be a media memory device or a player. That is, the external device 230 may be any of a camera, a DVD player, a Blu-ray player, a PC, etc.

The broadcasting station 210, the network server 220 or the external device 230 may transmit a signal including a video signal to the image display apparatus 100. The image display apparatus 100 may display an image based on the video signal included in the received signal. Also, the image display apparatus 100 may transmit a signal received from the broadcasting station 210 or the network server 220 to the external device 230 and may transmit a signal received from the external device 230 to the broadcasting station 210 or the network server 220. That is, the image display apparatus 100 may transmit content included in signals received from the broadcasting station 210, the network server 220, and the external device 230, as well as playback the content immediately.

FIG. 10 is a block diagram of the controller illustrated in FIG. 6.

Referring to FIG. 10, the controller 170 may include a DEMUX 310, a video processor 320, an OSD generator 340, a mixer 350, a Frame Rate Converter (FRC) 355, and a formatter 360 according to an embodiment of the present invention. The controller 170 may further include an audio processor and a data processor.

The DEMUX 310 demultiplexes an input stream. For example, the DEMUX 310 may demultiplex an MPEG-2 TS into a video signal, an audio signal, and a data signal. The input stream signal may be received from the tuner 110, the demodulator 120 or the external device interface 135.

The video processor 320 may process the demultiplexed video signal. For video signal processing, the video processor 320 may include a video decoder 325 and a scaler 335.

The video decoder 325 decodes the demultiplexed video signal and the scaler 335 scales the resolution of the decoded video signal so that the video signal can be displayed on the display 180.

The video decoder 325 may be provided with decoders that operate based on various standards.

If the demultiplexed video signal is, for example, an MPEC-2 encoded video signal, the video signal may be decoded by an MPEC-2 decoder.

On the other hand, if the video signal is an H.264-encoded DMB or DVB-handheld (DVB-H) signal, the video signal may be decoded by an H.264 decoder.

The video signal decoded by the video processor 320 is provided to the mixer 350.

The OSD generator 340 generates an OSD signal autonomously or according to user input. For example, the OSD generator 340 may generate signals by which a variety of information is displayed as images or text on the display 180, according to control signals received from the user input interface 150. The OSD signal may include various data such as a UI, a variety of menu screens, widgets, icons, etc.

For example, the OSD generator 340 may generate a signal by which subtitles are displayed for a broadcast image or Electronic Program Guide (EPG)-based broadcasting information.

The mixer 350 may mix the decoded video signal with the OSD signal and output the mixed signal to the formatter 360. As the decoded broadcast video signal or the external input signal is mixed with the OSD signal, an OSD may be overlaid on the broadcast image or the external input image.

The FRC 355 may change the frame rate of an input image. For example, a frame rate of 60 Hz is converted into a frame rate of 120 or 240 Hz. When the frame rate is to be changed from 60 Hz to 120 Hz, a first frame is inserted between the first frame and a second frame, or a predicted third frame is inserted between the first and second frames. If the frame rate is to be changed from 60 Hz to 240 Hz, three identical frames or three predicted frames are inserted between the first and second frames. It is also possible to maintain the frame rate of the input image without frame rate conversion.

The formatter 360 changes the format of the signal received from the FRC 355 to be suitable for the display 180. For example, the formatter 360 may convert a received signal into an RGB data signal. The RGB signal may be output in the form of a Low Voltage Differential Signal (LVDS) or mini-LVDS.

The audio processor of the controller 170 may process the demultiplexed audio signal. For audio signal processing, the audio processor may have a plurality of decoders.

If the demultiplexed audio signal is a coded audio signal, the audio processor of the controller 170 may decode the audio signal. For example, the demultiplexed audio signal may be decoded by an MPEG-2 decoder, an MPEG-4 decoder, an Advanced Audio Coding (AAC) decoder, or an AC-3 decoder.

The audio processor of the controller 170 may also adjust the bass, treble or volume of the audio signal.

The data processor of the controller 170 may process the data signal obtained by demultiplexing the input stream signal. For example, if the data signal is an encoded signal such as an EPG which includes broadcasting information specifying the start time, end time, etc. of scheduled broadcast TV or radio programs, the controller 170 may decode the data signal. Examples of an EPG include ATSC-Program and System Information Protocol (PSIP) information and DVB-Service Information (SI).

ATSC-PSIP information or DVB-SI may be included in the header of a TS, i.e., a 4-byte header of an MPEG-2 TS.

The block diagram of the controller 170 illustrated in FIG. 10 is an embodiment of the present invention. Depending upon the specifications of the controller 170, the components of the controller 170 may be combined, or omitted. Or new components are added to the controller 170.

FIG. 11 illustrates a platform architecture for either of the image display apparatuses according to an embodiment of the present invention and FIG. 12 illustrates a platform architecture for either of the image display apparatuses according to another embodiment of the present invention.

A platform for either of the image display apparatuses may have OS-based software to implement the above-described various operations according to an embodiment of the present invention.

Referring to FIG. 11, a platform for either of the image display apparatuses is a separate type according to an embodiment of the present invention. The platform may be designed separately as a legacy system platform 400 and a smart system platform 405. An OS kernel 410 may be shared between the legacy system platform 400 and the smart system platform 405.

The legacy system platform 400 may include a stack of a driver 420, middleware 430, and an application layer 450 on the OS kernel 410.

On the other hand, the smart system platform 405 may include a stack of a library 435, a framework 440, and an application layer 455 on the OS kernel 410.

The OS kernel 410 is the core of an operating system. When the image display apparatus is driven, the OS kernel 410 may be responsible for operation of at least one of hardware drivers, security protection for hardware and processors in the image display apparatus, efficient management of system resources, memory management, hardware interfacing by hardware abstraction, multi-processing, or scheduling associated with the multi-processing. Meanwhile, the OS kernel 410 may further perform power management.

The hardware drivers of the OS kernel 410 may include, for example, at least one of a display driver, a Wi-Fi driver, a Bluetooth driver, a USB driver, an audio driver, a power manager, a binder driver, or a memory driver.

Alternatively or additionally, the hardware drivers of the OS kernel 410 may be drivers for hardware devices within the OS kernel 410. The hardware drivers may include a character device driver, a block device driver, and a network device driver. The block device driver may need a buffer for buffering data on a block basis, because data is transmitted on a block basis. The character device driver may not need a buffer since data is transmitted on a basic data unit basis, that is, on a character basis.

The OS kernel 410 may be implemented based on any of various OSs such as Unix (Linux), Windows, etc. The OS kernel 410 may be a general-purpose open OS kernel which can be implemented in other electronic devices.

The driver 420 is interposed between the OS kernel 410 and the middleware 430. Along with the middleware 430, the driver 420 drives devices for operations of the application layer 450. For example, the driver 420 may include a driver(s) for a microcomputer, a display module, a Graphic Processing Unit (GPU), the FRC, a General-Purpose Input/Output (GPIO) pin, a High-Definition Multimedia Interface (HDMI), a System Decoder (SDEC) or DEMUX, a Video Decoder (VDEC), an Audio Decoder (ADEC), a Personal Video Recorder (PVR), and/or an Inter-Integrated Circuit (12C). These drivers operate in conjunction with the hardware drivers of the OS kernel 410.

In addition, the driver 420 may further include a driver for the remote controller 200, especially a pointing device to be described below. The remote controller driver may reside in the OS kernel 410 or the middleware 430, instead of the driver 420.

The middleware 430 resides between the OS kernel 410 and the application layer 450. The middleware 430 may mediate between different hardware devices or different software programs, for data transmission and reception between the hardware devices or the software programs. Therefore, the middleware 430 can provide standard interfaces, support various environments, and enable interaction between tasks conforming to heterogeneous communication protocols.

Examples of the middleware 430 in the legacy system platform 400 may include Multimedia and Hypermedia information coding Experts Group (MHEG) and Advanced Common Application Platform (ACAP) as data broadcasting-related middleware, PSIP or SI middleware as broadcasting information-related middleware, and DLNA middleware as peripheral device communication-related middleware.

The application layer 450 that runs atop the middleware 430 in the legacy system platform 400 may include, for example, UI applications associated with various menus in the image display apparatus. The application layer 450 may allow editing and updating over a network by user selection. With use of the application layer 450, the user may enter a desired menu among various Ills by manipulating the remote controller 210 while viewing a broadcast program.

The application layer 450 may further include at least one of a TV guide application, a Bluetooth application, a reservation application, a Digital Video Recorder (DVR) application, and a hotkey application.

In the smart system platform 405, the library 435 is positioned between the OS kernel 410 and the framework 440, forming the basis of the framework 440. For example, the library 435 may include Secure Socket Layer (SSL) being a security-related library, WebKit being a Web engine-related library, c library (libc), and Media Framework being a media-related library specifying, for example, a video format and an audio format. The library 435 may be written in C or C++. Also, the library 435 may be exposed to a developer through the framework 440.

The library 435 may include a runtime 437 with a core Java library and a Virtual Machine (VM). The runtime 437 and the library 435 form the basis of the framework 440.

The VM may be a virtual machine that enables concurrent execution of a plurality of instances, that is, multi-tasking. For each application of the application layer 455, a VM may be allocated and executed. For scheduling or interconnection between instances, the binder driver of the OS kernel 410 may operate.

The binder driver and the runtime 437 may connect Java applications to C-based libraries.

The library 435 and the runtime 437 may correspond to the middleware 430 of the legacy system platform 400.

In the smart system platform 405, the framework 440 includes programs on which applications of the application layer 455 are based. The framework 440 is compatible with any application and may allow component reuse, movement or exchange. The framework 440 may include supporting programs and programs for interconnecting different software components. For example, the framework 440 may include an activity manager related to activities of applications, a notification manager, and a CP for abstracting common information between applications. This framework 440 may be written in Java.

The application layer 455 on top of the framework 440 includes a variety of programs that are executed and displayed in the image display apparatus. The application layer 455 may include, for example, a core application that is a suit having at least one solution of e-mail, Short Message Service (SMS), calendar, map, or browser. The application layer 455 may be written in Java.

In the application layer 455, applications may be categorized into user-undeletable applications 465 stored in the image display apparatus 100 that cannot be modified and user-installable or user-deletable applications 475 that are downloaded from an external device or a network and stored in the image display apparatus.

With the applications of the application layer 455, a variety of functions such as Internet telephony, VoD, Web album, Social Networking Service (SNS), Location-Based Service (LBS), map service, Web browsing, and application search may be performed through network access. In addition, other functions such as gaming and schedule management may be performed by the applications.

Referring to FIG. 12, a platform for the image display apparatus according to another embodiment of the present invention is an integrated type. The integrated platform may include an OS kernel 510, a driver 520, middleware 530, a framework 540, and an application layer 550.

Compared to the separate-type platform illustrated in FIG. 11, the integrated-type platform is characterized by the absence of the library 435 and the application layer 550 being an integrated layer. The driver 520 and the framework 540 correspond to the driver 420 and the framework 440 of FIG. 5, respectively.

The library 435 of FIG. 11 may be incorporated into the middleware 530. That is, the middleware 530 may include both the legacy system middleware and the image display system middleware. As described before, the legacy system middleware includes MHEG or ACAP as data broadcasting-related middleware, PSIP or SI middleware as broadcasting information-related middleware, and DLNA middleware as peripheral device communication-related middleware, whereas the image display system middleware includes SSL as a security-related library, WebKit as a Web engine-related library, libc, and Media Framework as a media-related library. The middleware 530 may further include the afore-described runtime.

The application layer 550 may include a menu-related application, a TV guide application, a reservation application, etc. as legacy system applications, and e-mail, SMS, a calendar, a map, and a browser as image display system applications.

In the application layer 550, applications may be categorized into user-undeletable applications 565 that are stored in the image display apparatus and user-installable or user-deletable applications 575 that are downloaded from an external device or a network and stored in the image display apparatus.

Based on the afore-described platforms illustrated in FIGS. 11 and 12, a variety of Application Programming Interfaces (APIs) and Software Development Kits (SDKs) necessary to develop applications may be opened. APIs may be implemented functions that provide connectivity to specific sub-routines, for execution of the functions within a program. Or APIs may be implemented programs.

For example, sources related to hardware drivers of the OS kernel 410, such as a display driver, a WiFi driver, a Bluetooth driver, a USB driver or an audio driver, may be opened. Related sources within the driver 420 such as a driver for a microcomputer, a display module, a GPU, an FRC, an SDEC, a VDEC, an ADEC or a pointing device may be opened. In addition, sources related to PSIP or SI middleware as broadcasting information-related middleware or sources related to DLNA middleware may be opened.

Such various open APIs allow developers to create applications executable in the image display apparatus 100 or applications required to control operations of the image display apparatus 100 based on the platforms illustrated in FIGS. 11 and 12.

The platforms illustrated in FIGS. 11 and 12 may be general-purpose ones that can be implemented in many other electronic devices as well as in image display apparatuses. The platforms may be stored or loaded in the memory 140, the controller 170, or any other processor. To execute applications, an additional application processor may be further provided.

FIG. 13 illustrates a method for controlling either of the image display apparatuses using a remote controller according to an embodiment of the present invention.

FIG. 13(a) illustrates a pointer 205 representing movement of the remote controller 200 displayed on the display 180.

The user may move or rotate the remote controller 200 up and down, side to side (FIG. 13(b)), and back and forth (FIG. 13(c)). Since the pointer 205 moves in accordance with the movement of the remote controller 200, the remote controller 200 may be referred to as a pointing device.

Referring to FIG. 13(b), if the user moves the remote controller 200 to the left, the pointer 205 moves to the left on the display 180. A sensor of the remote controller 200 detects the movement of the remote controller 200 and transmits motion information corresponding to the result of the detection to the image display apparatus. Then, the image display apparatus determines the movement of the remote controller 200 based on the motion information received from the remote controller 200, and calculates the coordinates of a target point to which the pointer 205 should be shifted in accordance with the movement of the remote controller 200 based on the result of the determination. The image display apparatus then displays the pointer 205 at the calculated coordinates.

Referring to FIG. 13(c), while pressing a predetermined button of the remote controller 200, the user moves the remote controller 200 away from the display 180. Then, a selected area corresponding to the pointer 205 may be zoomed in on and enlarged on the display 180. On the contrary, if the user moves the remote controller 200 toward the display 180, the selection area corresponding to the pointer 205 is zoomed out and thus contracted on the display 180. The opposite case is possible. That is, when the remote controller 200 moves away from the display 180, the selection area may be zoomed out and when the remote controller 200 approaches the display 180, the selection area may be zoomed in.

With the predetermined button pressed in the remote controller 200, the up, down, left and right movements of the remote controller 200 may be ignored. That is, when the remote controller 200 moves away from or approaches the display 180, only the back and forth movements of the remote controller 200 are sensed, while the up, down, left and right movements of the remote controller 200 are ignored. Unless the predetermined button is pressed in the remote controller 200, the pointer 205 moves in accordance with the up, down, left or right movement of the remote controller 200.

The speed and direction of the pointer 205 may correspond to the speed and direction of the remote controller 200.

The pointer 205 is an object displayed on the display 180 in correspondence with the movement of the remote controller 200. Therefore, the pointer 205 may have various shapes other than the arrow illustrated in FIG. 13. For example, the pointer 205 may be a dot, a cursor, a prompt, a thick outline, etc. The pointer 205 may be displayed across a plurality of points, such as a line and a surface, as well as at a single point on horizontal and vertical axes.

FIG. 14 is a detailed block diagram of the remote controller in either of the image display apparatuses according to an embodiment of the present invention.

Referring to FIG. 14, the remote controller 200 may include a wireless communication module 225, a user input unit 235, a sensor unit 240, an output unit 250, a power supply 260, a memory 270, and a controller 280.

The wireless communication module 225 transmits signals to and/or receives signals from either of the afore-described image display apparatuses according to the embodiments of the present invention, herein, the image display apparatus 100.

The wireless communication module 225 may include an RF module 221 for transmitting RF signals to and/or receiving RF signals from the image display apparatus 100 according to an RF communication standard. The wireless communication module 225 may also include an IR module 223 for transmitting IR signals to and/or receiving IR signals from the image display apparatus 100 according to an IR communication standard.

The remote controller 200 transmits motion information representing the movement of the remote controller 200 to the image display apparatus 100 through the RF module 221 in this embodiment. The remote controller 200 may also receive signals from the image display apparatus 100 through the RF module 221. As needed, the remote controller 200 may transmit commands such as a power on/off command, a channel switch command, or a volume change command to the image display apparatus 100 through the IR module 223.

The user input unit 235 may include a keypad, a plurality of buttons, a touchpad and/or a touch screen. The user may enter commands to the image display apparatus 100 by manipulating the user input unit 235. If the user input unit 235 includes a plurality of hard buttons, the user may input various commands to the image display apparatus 100 by pressing the hard buttons. Alternatively or additionally, if the user input unit 235 includes a touch screen displaying a plurality of soft keys, the user may input various commands to the image display apparatus 100 by touching the soft keys. The user input unit 235 may also include various input tools other than those set forth herein, such as a scroll key and/or a jog wheel, which should not be construed as limiting the present invention.

The sensor unit 240 may include a gyro sensor 241 and/or an acceleration sensor 243. The gyro sensor 241 may sense the movement of the remote controller 200, for example, in X-, Y-, and Z-axis directions, and the acceleration sensor 243 may sense the speed of the remote controller 200. The sensor unit 240 may further include a distance sensor for sensing the distance between the remote controller 200 and the display 180.

The output unit 250 may output a video and/or audio signal corresponding to manipulation of the user input unit 235 or corresponding to a signal received from the image display apparatus 100. The user may easily identify whether the user input unit 235 has been manipulated or whether the image display apparatus 100 has been controlled, based on the video and/or audio signal output by the output unit 250.

The output unit 250 may include a Light Emitting Diode (LED) module 351 which is turned on or off whenever the user input unit 235 is manipulated or whenever a signal is received from or transmitted to the image display apparatus 100 through the wireless communication module 225, a vibration module 253 which generates vibrations, an audio output module 255 which outputs audio data, and/or a display module 257 which outputs video data.

The power supply 260 supplies power to the remote controller 200. If the remote controller 200 is kept stationary for a predetermined time or longer, the power supply 260 may, for example, reduce or shut off supply of power to the spatial remote controller 200 in order to save power. The power supply 260 may resume power supply if a predetermined key on the spatial remote controller 200 is manipulated.

The memory 270 may store various types of programs and application data necessary to control or drive the remote controller 200. The spatial remote controller 200 may wirelessly transmit signals to and/or receive signals from the image display apparatus 100 over a predetermined frequency band with the aid of the RF module 221. The controller 280 of the remote controller 200 may store information regarding the frequency band used for the remote controller 200 to wirelessly transmit signals to and/or wirelessly receive signals from the paired image display apparatus 100 in the memory 270, for later use.

The controller 280 provides overall control to the remote controller 200. The controller 280 may transmit a signal corresponding to a key manipulation detected from the user input unit 235 or a signal corresponding to motion of the spatial remote controller 200, as sensed by the sensor unit 240, to the image display apparatus 100.

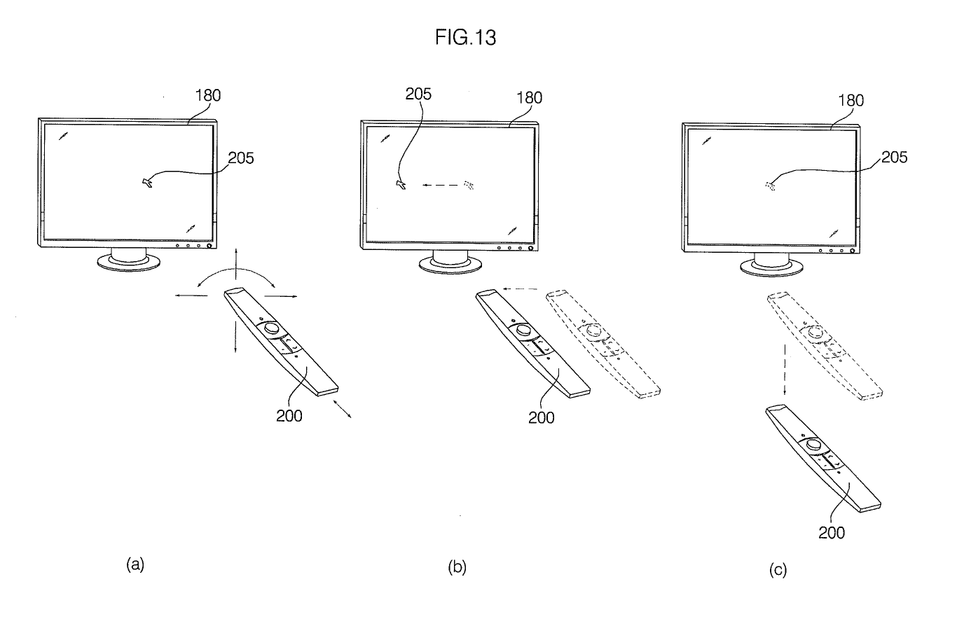

FIGS. 15 to 18 illustrate UIs in either of the image display apparatuses according to embodiments of the present invention.

Referring to FIG. 15, an application list available from a network is displayed on the display 180. A user may access a CP or an NP directly, search for various applications, and download the applications from the CP or the NP.

Specifically, FIG. 15(a) illustrates an application list 610 available in a connected server, displayed on the display 180. The application list 610 may include an icon representing each application and a brief description of the application. Because each of the image display apparatuses according to the embodiments of the present invention is capable of full browsing, it may enlarge the icons or descriptions of applications received from the connected server on the display 180. Accordingly, the user can readily identify applications, which will be described later.

FIG. 15(b) illustrates selection of one application 620 from the application list 610 using the pointer 205 of the remote controller 200. Thus, the selected application 620 may be easily downloaded.

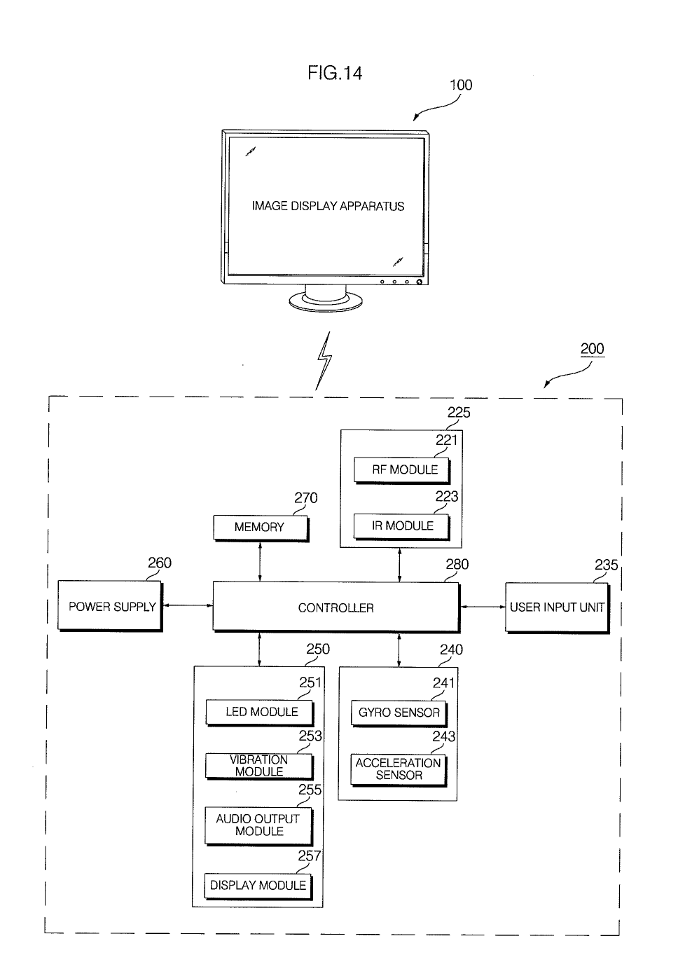

FIG. 16 illustrates an application list available in the image display apparatus, displayed on the display 180. Referring to FIG. 16(a), when the user selects an application list view menu by manipulating the remote controller 200, a list of applications 660 stored in the image display apparatus is displayed on the display 180. While only icons representing the applications are shown in FIG. 16, the application list 660 may further include brief descriptions of the applications, like the application list 610 illustrated in FIG. 15. Therefore, the user can readily identify the applications.

FIG. 16(b) illustrates selection of one application 670 from the application list 660 using the pointer 205 of the remote controller 200. Thus, the selected application 670 may be easily executed.

While it is shown in FIGS. 15 and 16 that the user selects a desired application by moving the pointer 205 using the remote controller 200, the application may be selected in many other ways. For example, the user may select a specific application using a cursor displayed on the display 180 by a combined input of a local key and an OK key in the remote controller 200.

In another example, if the remote controller 200 has a touch pad, the pointer 205 moves on the display 180 according to touch input of the touch pad. Thus the user may select a specific menu using the touch-based pointer 205.

FIG. 17 illustrates a Web page displayed on the display 180. Specifically, FIG. 17(a) illustrates a Web page 710 with a search window 720, displayed on the display 180. The user may enter a character into the search window 720 by use of character keys of a keypad displayed on a screen, character keys provided as local keys, or character keys of the remote controller 200.

FIG. 17(b) illustrates a search result page 730 having search results matching a keyword entered into the search window 720. Since the image display apparatuses according to the embodiments of the present invention are capable of fully browsing a Web page, the user can easily read the Web page.

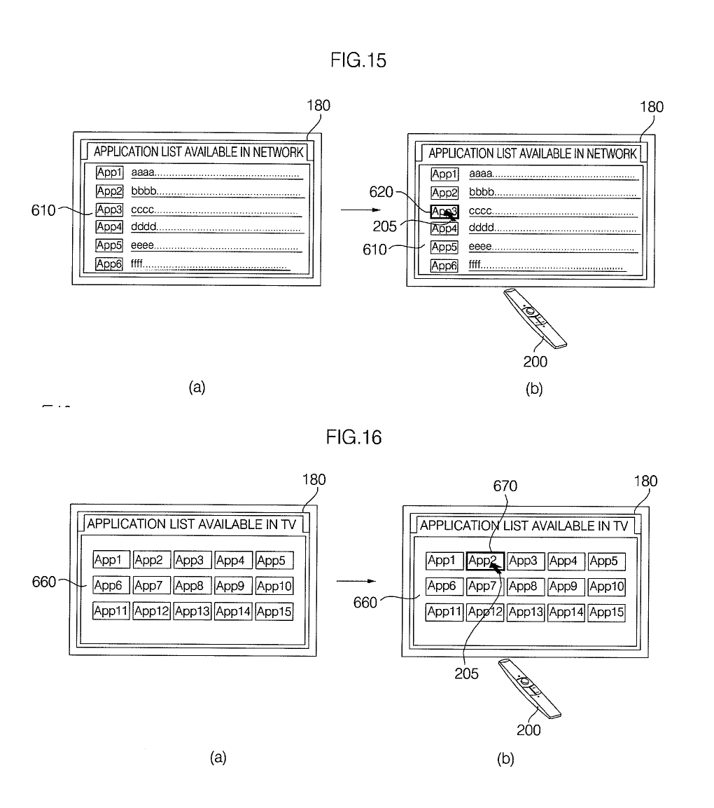

FIG. 18 illustrates another Web page displayed on the display 180. Specifically, FIG. 18(a) illustrates a mail service page 810 including an ID input window 820 and a password input window 825, displayed on the display 180. The user may enter a specific numeral and/or text into the ID input window 820 and the password input window 825 using a keypad displayed on the mail service page 810, character keys provided as local keys, or character keys of the remote controller 200. Hence, the user can log in to a mail service.

FIG. 18(b) illustrates a mail page 830 displayed on the display 180, after log-in to the mail service. For example, the mail page 830 may contains items “read mail”, “write mail”, “sent box”, “received box”, “recycle bin”, etc. In the “received box” item, mail may be ordered by sender or by title.

The image display apparatuses according to the embodiments of the present invention are capable of full browsing when displaying a mail service page. Therefore, the user can use the mail service conveniently.

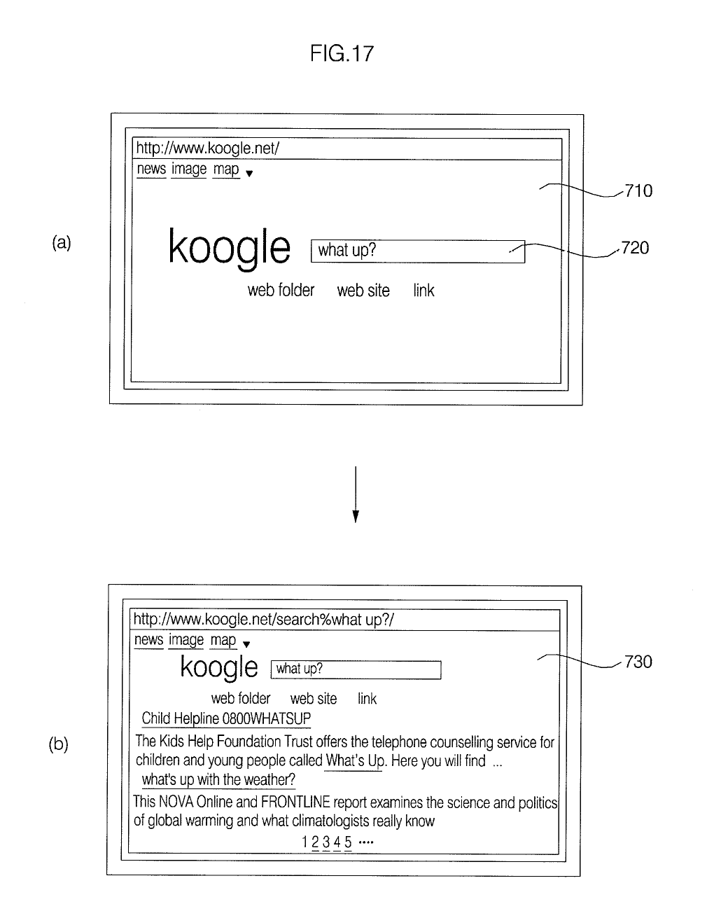

FIG. 19 illustrates an exemplary home screen displayed on the display 180.

The home screen configuration illustrated in FIG. 19 may be an example of a default screen configuration for a smart TV. The home screen may be set as an initial screen that is displayed when the image display apparatus 100 is powered on or wakes up from standby mode, or as a default screen that is displayed when a local key or a home key of the remote controller 200 is manipulated.

Referring to FIG. 19, a card object area may be defined in a home screen 1300. The card object area may include a plurality of card objects 1310, 1320 and 1330 classified according to content sources.

In the illustrated case of FIG. 19, the card object 1310 is named BROADCAST and displays a broadcast image. The card object 1320 is named NETCAST and provides a CP list. The card object 1330, which is named APP STORE, provides a list of applications.

Other card objects may be arranged in a hidden area 1301 and thus hidden from the display 180. These card objects may be shifted to show up on the display 180, substituting for card objects displayed on the display 180. The hidden card objects are a CHANNEL BROWSER card object 1340 for providing a thumbnail list of broadcast channels, a TV GUIDE card object 1350 for providing a program list, a RESERVATION/REC card object 1360 for providing a reserved or recorded program list, a MY MEDIA card object 1370 for providing a media list available in the image display apparatus 100 or in a device connected to the image display apparatus 100, an EXTERNAL DEVICE card object 1380 for providing a list of connected external devices and a PHONE card object 1390 for providing a call-related list.

The BROADCAST card object 1310 may contain a broadcast image 1315 received through the tuner 110 or the network interface 130, an object 1321 for providing information about the broadcast image 1315, an object 1317 representing an external device and a setup object 1318.

The broadcast image 1315 is displayed as a card object. Since the broadcast image 1315 may be fixed in size by a lock function, the user may continue viewing the broadcast image 1315 conveniently.

It is also possible to scale the broadcast image 1315 according to user manipulation. For instance, the broadcast image 1315 may be enlarged or contracted by dragging the broadcast image 1315 with the pointer 205 of the remote controller 200. As the broadcast image 1315 is scaled up or down, four or two card objects may be displayed on the display 180, instead of the current three card objects.

When the broadcast image 1315 is selected in the card object 1310, the broadcast image 1315 may be fullscreened on the display 180.

The object 1321 representing information about the broadcast image 1315 may include a channel number (DTV7-1), a channel name (YBC HD), the title of a broadcast program (Oh! Lady), and airing time (8:00-8:50 PM) of the broadcast program. Therefore, the user can be readily aware of information about the displayed broadcast image 1315.

If the user selects the object 1321, related EPG information may be displayed on the display 180.

An object 1302 for notifying a date (03.24), a day (THU), and a current time (8:13 PM) may be positioned above the card object 1310 that displays a broadcast image. Thus the user can identify time information readily through the object 1302.

The object 1317 may represent an external device connected to the image display apparatus 100. For example, if the object 1317 is selected, a list of external devices connected to the image display apparatus 100 may be displayed.

The setup object 1318 may be used to set various settings of the image display apparatus 100, such as video settings, audio settings, screen settings, reservation settings, setting of the pointer 205 of the remote controller 200, and network settings.

The card object 1320 representing a CP list may contain a card object name 1322 (NETCAST) and a CP list 1325. While Yakoo, Metflix, weather.com, Pcason, and My tube are shown as CPs in the CP list 1325 in FIG. 19, other settings may be used.

Upon selection of the card object name 1322, the card object 1320 may be displayed fullscreen on the display 180. The same may apply to other card objects.

If a specific CP is selected from the CP list 1325, a screen with a list of content provided by the selected CP may be displayed on the display 180.

The card object 1330 representing an application list may include a card object name 1332 (APP STORE) and an application list 1335. Applications may be sorted into predetermined categories in the application list 1335. In the illustrated case of FIG. 19, applications are sorted by popularity (HOT) and by time (NEW), which should not be interpreted as limiting the present invention.

Upon selection of an application from the application list 1335, a screen that provides information about the selected application may be displayed on the display 180.

A Log-in menu item 1327, a Help menu item 1328, and an Exit menu item 1329 may be displayed above the card objects 1320 and 1330.

The user may log in to the APP STORE or a network connected to the image display apparatus 100 using the Log-in menu item 1327. The Help menu item 1328 provides guidance on operation of the image display apparatus 100. The Exit menu item 1329 is used to exit the home screen. When the Exit menu item 1329 is selected, a received broadcast image may be fullscreened on the display 180.

An object 1337 may be displayed under the card objects 1320 and 1330 to indicate the total number of available card objects. Alternatively or additionally, the object 1337 may indicate the number of card objects being displayed on the display 180 as well.

The card object 1340 representing a thumbnail list of broadcast channels may include a card object name 1342 (CHANNEL BROWSER) and a thumbnail list of broadcast channels 1345. Sequentially received broadcast channels are represented as thumbnail images in FIG. 19. The thumbnail images may be still images or moving pictures. The thumbnail list 1345 may include information about the channels along with the thumbnail images of the channels, so that the user can readily identify broadcast programs of the channels. The thumbnail images may be thumbnail images of pre-stored user favorite channels or thumbnail images of channels following or previous to the channel of the broadcast image 1315 displayed in the card object 1310. Although eight thumbnail images are displayed in FIG. 9, many other configurations are possible. Thumbnail images may be updated in the thumbnail list 1345.

Upon selection of a thumbnail image from the thumbnail list 1345, a broadcast image corresponding to the channel of the selected thumbnail image may be displayed on the display 180.

The card object 1350 providing a program list may contain a card object name 1352 (TV GUIDE) and a program list 1355. The program list 1355 may list broadcast programs that air after the broadcast program of the broadcast image 1315 or broadcast programs of other channels, to which the present invention is not limited.

If a program is selected from the program list 1355, a broadcast image of the selected program or broadcasting information about the selected program may be displayed on the display 180.

The card object 1360 representing a reserved or recorded program list may include a card object name 1362 (RESERVATION/REC) and a reserved or recorded program list 1365. The reserved or recorded program list 1365 may include user-reserved programs or programs recorded by reservation. While a thumbnail image is displayed for each program, this is merely an exemplary application and thus various examples can be considered.

Upon selection of a reserved program or a recorded program from the reserved or recorded program list 1365, broadcast information about the reserved or recorded broadcast program or broadcast images of the recorded broadcast program may be displayed on the display 180.

The card object 1370 representing a media list may include a card object name 1372 (MY OBJECT) and a media list 1375. The media list 1375 may list media available in the image display apparatus 100 or a device connected to the image display apparatus 100. While the media are shown as moving pictures, still images, and audio in FIG. 19, many other media such as text, e-books, etc. may be added to the media.

Upon selection of a file from the media list 1375, the selected file may be opened and a screen corresponding to the selected file may be displayed on the display 180.

The card object 1380 representing a list of connected external devices may contain a card object name 1382 (EXTERNAL DEVICE) and a list 1385 of external devices connected to the image display apparatus 100. The external device list 1385 includes a gaming box, a DVD player, and a computer in FIG. 19, by way of example.

Upon selection of the card object name 1382, the card object 1380 may be displayed fullscreen on the display 180.

Upon selection of a specific external device from the external device list 1385, a menu related to the selected external device may be executed. For example, content may be played back from the external device and a screen corresponding to the reproduced content may be displayed on the display 180.

The card object 1390 representing a call-related list may include a card object name 1392 (PHONE) and a call-related list 1395. The call-related list 1395 may be a listing related to calls conducted in a portable phone, a computer, or the image display apparatus 100 capable of placing calls. For instance, the call-related list 1395 may include a message item, a phone book item, or a setting item. Upon receipt of an incoming call at the portable phone, the computer or the image display apparatus 100, the call-related card object 1390 may automatically show up in the card object area of the display 180. If the card object 1390 has already been displayed on the display 180, it may be focused on (highlighted).

Therefore, the user can readily identify incoming calls of a nearby portable phone, a computer, or the image display apparatus 100. This is interactive function among the portable phone, the computer, and the image display apparatus, called a 3-screen function.

Upon selection of the card object name 1392, the card object 1390 may be fullscreened on the display 180.

Upon selection of a specific item from the call-related list 1395, a screen corresponding to the selected item may be displayed on the display 180.

In FIG. 19, the card objects 1310, 1320 and 1330 are displayed in the card object area 1300, and the card objects 1340 to 1390 are placed in the hidden area 1301, by way of example.

The card objects 1320 and 1330 displayed on the display 180 may be exchanged with the hidden card objects 1340 to 1390 according to a card object shift input. Specifically, at least one of the card objects 1320 and 1330 being displayed on the display 180 may move to the hidden area 1301 and in turn, at least one of the hidden objects 1340 to 1390 may show up on the display 180.

An application menu 1305 includes a plurality of application menu items, particularly predetermined menu items 1306 to 1309 selected from among all available application menu items on the display 180. Thus the application menu 1305 may be referred to as an application compact-view menu.

The application menu items 1306 to 1309 may be divided into preferred application menu items 1306, 1307 and 1309 (Search, App Store, and +) and optional application menu items 1308 (Music, Book, MAZON, and SNS) set by the user.

The preferred application menu items 1306, 1307 and 1309 may be fixed such that the user is not allowed to edit the same. The Search application menu item 1306 provides a search function based on an input search keyword. The App Store application menu item 1307 enables the user to access an AppStore directly. The +(View More) application menu item 1309 may provide a fullscreen function.

In an exemplary embodiment of the present invention, an Internet application menu item and a mail application menu item may be added as preferred application menu items in the application menu 1305.

The user-set application menu items 1308 may be edited to represent applications that the user often uses.

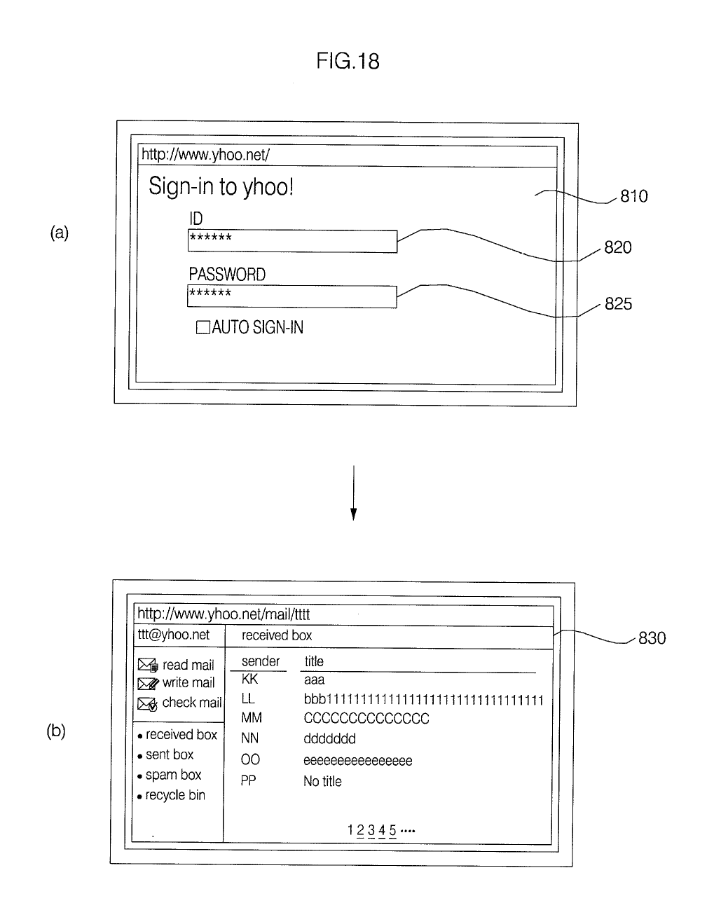

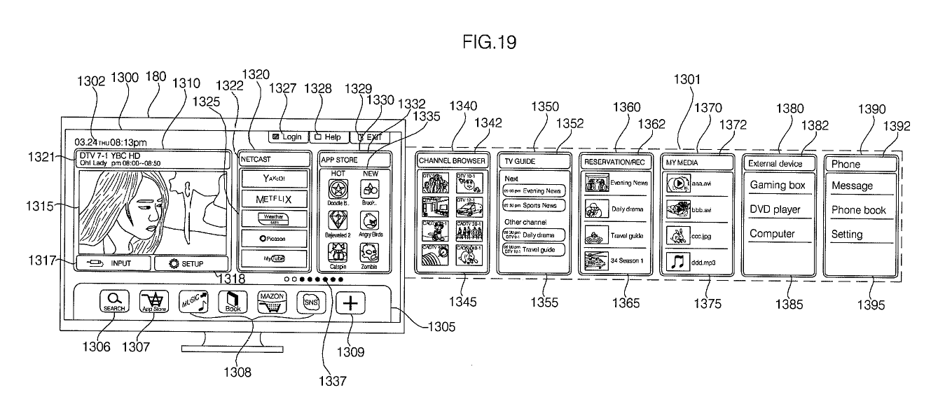

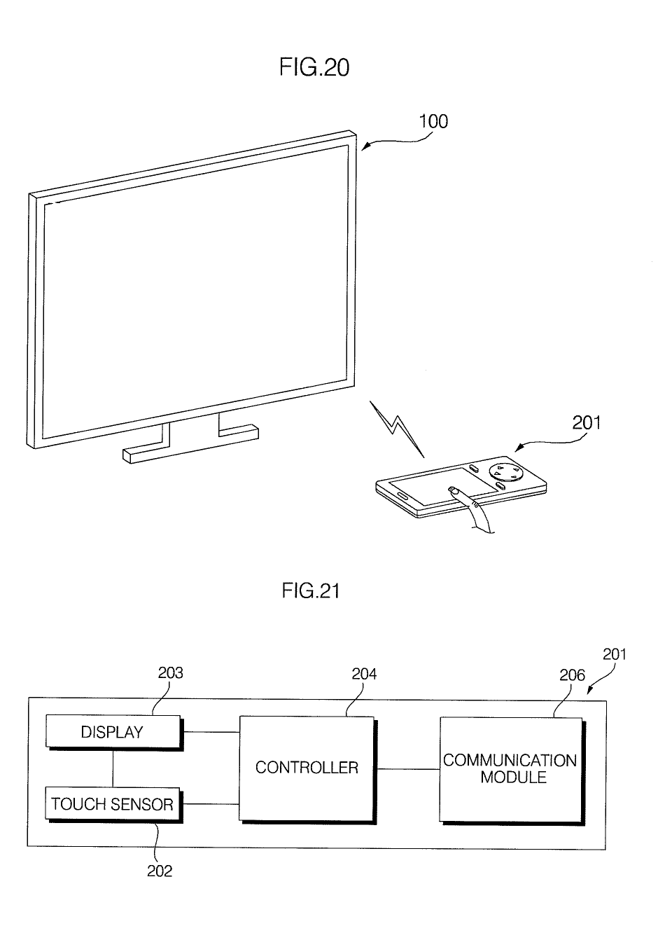

FIG. 20 illustrates the exteriors of a remote controller 201 and the image display apparatus 100 according to an embodiment of the present invention.

As stated before, the remote controller 201 is capable of transmitting a signal including a control command to the image display apparatus 100. In accordance with this embodiment, the remote controller 201 may transmit signals to and receive signals from the image display apparatus 100 according to an RF or IR communication standard. The image display apparatus 100 may move an object displayed on the display 180 according to a signal received from the remote controller 201.

An object displayed on the display 180 of the image display apparatus 100 may be an image of content being played back from the image display apparatus 100 or an image of an application being executed in the image display apparatus 100. The object may also be an object such as a figure or an item included in an image displayed in the image display apparatus 100. Further, the object may be an icon, a widget, a window, a pointer, etc. displayed in the image display apparatus 100.

The movement speed or direction of an object displayed on the image display apparatus 100 may depend on a user touch pattern on a touch screen of the remote controller 201. The remote controller 201 transmits a signal including information about the user touch pattern on the touch screen to the image display apparatus 100. Then the image display apparatus 100 may move the displayed object according to the information about the touch pattern.

As described before, the remote controller 201 may transmit a signal representing user motion to the image display apparatus 100. In this case, the remote controller 201 may be provided with a motion sensor for sensing user motion. The user may move or rotate the remote controller 201 up, down, to the left, to the right, back or forth. In this case, the speed or direction of the displayed object may correspond to movement of the remote controller 201. This may be known as panning.

For instance, when the user moves the remote controller 201 to the left, an object displayed on the image display apparatus 100 may also move to the left. Motion information representing the movement of the remote controller 201 as sensed by the motion sensor thereof is transmitted to the image display apparatus 100. The image display apparatus 100 may calculate the coordinates of a target position to which the object should be moved on the display 180 of the image display apparatus. Then the image display apparatus 100 may move the object to the target position.

As described above, the remote controller 201 may transmit a signal including information about a user touch pattern on the touch screen or a signal including information about a movement that the user has made to manipulate the remote controller 201 to the image display apparatus 100. Accordingly, the remote controller 201 may include a device for transmitting a signal including at least one of the touch pattern information or the user motion information to the image display apparatus 100, as needed, according to the embodiment of the present invention. It should be understood that the operations of the remote controller according to the following embodiments of the present invention do not limit the scope of the present invention.

FIG. 21 is a block diagram of the remote controller 201 according to an embodiment of the present invention.

Referring to FIG. 21, the remote controller 201 includes a touch sensor 202, a display 203, a controller 204, and a communication module 206.

The touch sensor 202 may identify a user touch pattern. The display 203 may display a UI. In the embodiment of the present invention, the touch sensor 202 and the display 203 may collectively form a touch screen installed on the exterior of the remote controller 201.

The user may input a command for controlling the image display apparatus 100 to the remote controller 201 by touching the touch screen. The remote controller 201 may display a UI related to the image display apparatus 100 on the touch screen so that the user touches the touch screen of the remote controller 201 with reference to the UI.

The remote controller 201 may calculate the coordinates of a touched area and transmit a signal including information about the coordinates of the touched area to the image display apparatus 100. Then the image display apparatus 100 determines a control command corresponding to the coordinates included in the received signal and operates according to the control command.

The controller 204 controls the communication module 205 to transmit a signal representing a user touch pattern sensed by the touch sensor 202 to the image display apparatus 100. In addition, the controller 204 outputs an image signal to the display 203 to display an image on the display 203.

The remote controller 201 may process a signal received from the image display apparatus 100 through the communication module 206 such that an image corresponding to the received signal is displayed on the display 203. The controller 204 may output an image signal based on the processed signal to the display 203.

More specifically, the image display apparatus 100, which is controlled according to a signal received from the remote controller 201, may transmit a feedback signal to the remote controller 201. The controller 204 of the remote controller 201 processes an image signal and outputs it to the display 203 so that an image based on the feedback signal may be displayed on the display 203. Accordingly, the user can confirm the state of the image display apparatus 100 that has been controlled based on a user touch pattern, through the display 203.

The communication module 206 may transmit signals to or receive signals from the image display apparatus 100. In this embodiment, the remote controller 201 may include an RF module and/or an IR module to transmit signals to and receive signals from the image display apparatus 100 according to an RF and/or IR communication standard.

In the embodiment of the present invention, the remote controller 201 may transmit a signal including information about movement of the remote controller 201 to the image display apparatus 100 through the RF module, and may receive a signal from the image display apparatus 100 through the RF module. As needed, the remote controller 201 may transmit commands such as a power on/off command, a channel switch command, a volume change command, etc. to the image display apparatus 100 through the IR module.

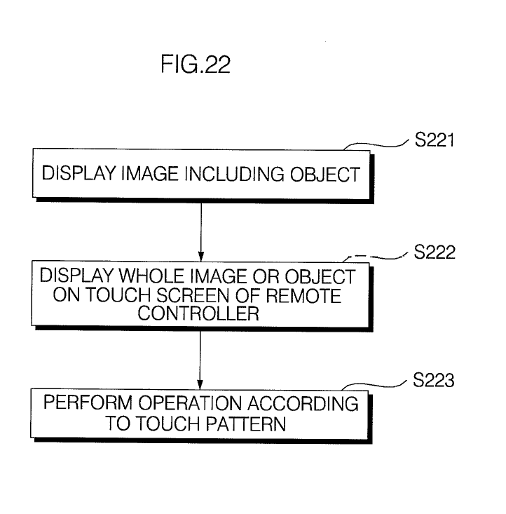

FIG. 22 is a flowchart illustrating a method for operating an image display apparatus according to an embodiment of the present invention.

Referring to FIG. 22, a menu image with one or more selectable objects is displayed (S221) and the menu image or the objects are displayed on the touch screen of the remote controller (S222). An operation corresponding to a user touch pattern on the touch screen is performed (S223).

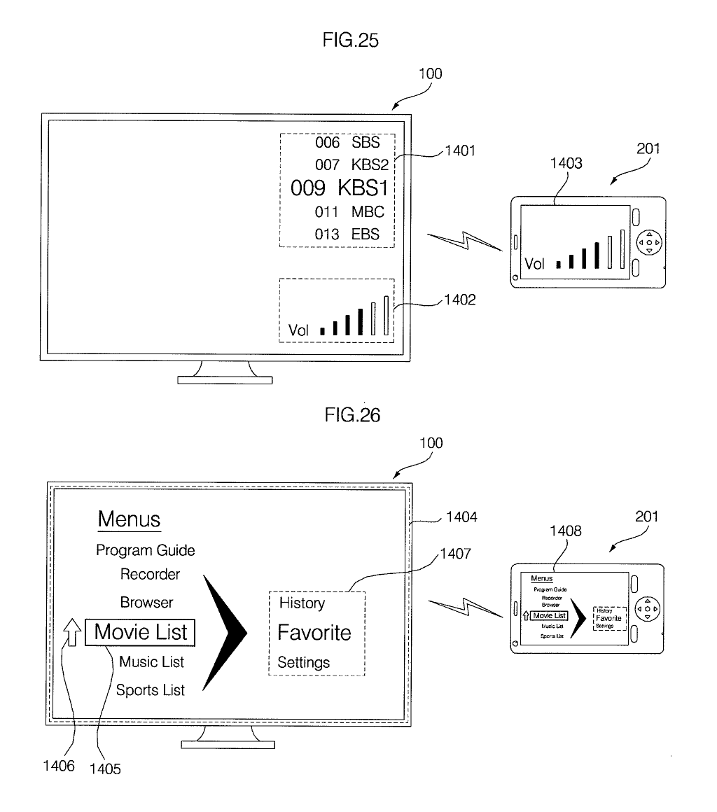

Referring to FIG. 25, selectable objects, for example, a channel list 1401 and a volume object 1402 may be displayed on the display 180 of the image display apparatus 100. These selectable objects may be shown while displaying a live broadcast image, a recorded broadcast image, a music file, or other objects.

An individual object such as the volume object 1402 can be displayed on the touch screen of the remote controller 201 alone. Alternatively or additionally, a whole image displayed on the display 180 may also be displayed on the touch screen of the remote controller 201, as illustrated in FIG. 26.

Referring to FIG. 26, the image display apparatus 100 displays a menu screen 1404 including a menu list on the display 180 and the remote controller 201 displays a menu screen 1408 which is a scaled-down version of the menu screen 1404 on the screen. In this embodiment, the image display apparatus 100 may scroll menu items included in the menu list according to information about a user touch pattern received from the remote controller 201.

A sub-menu list 1407 of a selected or highlighted menu item 1405 may further be displayed on the display 180. When scrolling the menu list, the image display apparatus 100 may further display an object 1406 indicating a scroll direction on the display 180.

Because the touch screen of the remote controller 201 displays at least a part of the same image displayed on the display 180 of the image display apparatus 100, the user can readily identify objects such as menus. Also, the user can select or change a menu easily by touching the touch screen of the remote controller 201.

The image display apparatus 100 may perform an operation such as channel switching, volume change, etc. according to a touch pattern on the touch screen of the remote controller 201 and a control command corresponding to the touch pattern.

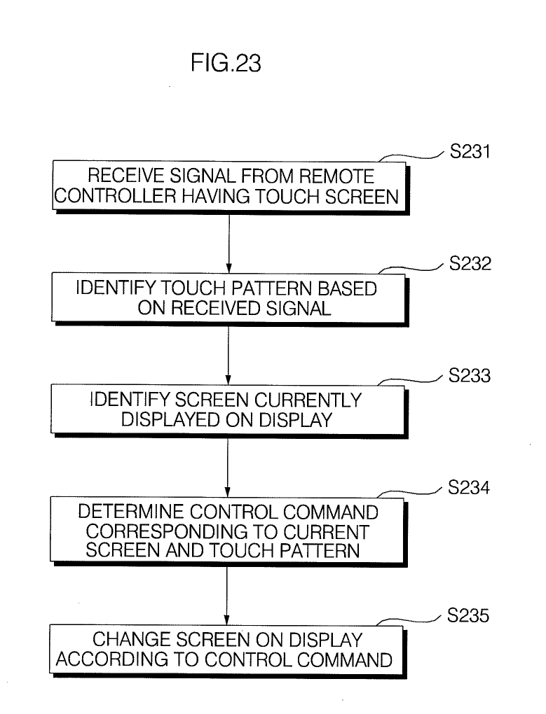

FIG. 23 is a flowchart illustrating a method for controlling an operation of the image display apparatus according to an embodiment of the present invention.

Referring to FIG. 23, the image display apparatus 100 receives a signal from the remote controller 201 having the touch screen (S231). The remote controller 201 may transmit a signal including information about a user touch pattern on the touch screen to the image display apparatus 100 through the RF module and thus the image display apparatus 100 may receive the signal that has been transmitted from the remote controller 201 through the RF module. The image display apparatus 100 may communicate with the remote controller 201 wirelessly after pairing.

The image display apparatus 100 identifies the user touch pattern from the received signal (S232). The touch pattern information specifies at least one of the number of touches on the touch screen, the interval between touches, a touch duration, a touch pressure applied to the touch screen, a touched area, or a dragging direction after a touch. The touch patterns described above may be a single touch pattern, a sequence of touch patterns, or two or more simultaneous touch patterns (e.g., two fingers moving in a common or opposite directions, or one constant touch with another touch operation.)

The image display apparatus 100 determines a current image displayed on the display 180 (S233). In an exemplary embodiment, a menu list or at least a part of content may be displayed on the display 180. The image display apparatus 100 identifies content or an object being displayed on the display 180 because the touch pattern may be interpreted as a different control command according to the displayed content or object.

The image display apparatus 100 determines a control command corresponding to the currently displayed image and the touch pattern (S234). The same touch pattern information may control the image display apparatus 100 in different ways according to a currently displayed screen.

For example, when the user taps an upper part of the touch screen, the remote controller 201 transmits a signal including information about the touch pattern to the image display apparatus 100. With a channel list displayed on the display 180, the image display apparatus 100 may determine a control command corresponding to the touch pattern to be a channel list scroll command. In another example, with a menu list displayed on the display 180, the image display apparatus 100 may determine the control command corresponding to the same touch pattern to be a menu list scroll command. In a further example, with part of content displayed on the display 180, the image display apparatus 100 may determine the control command corresponding to the same touch pattern to be a content zoom-in command.

The image display apparatus 100 changes the current screen on the display 180 according to the determined control command (S235). As described above, if the current screen displays a channel list, the image display apparatus 100 may change the current screen to a screen with a scrolled channel list. If the current screen displays a menu list, the image display apparatus 100 may change the current screen to a screen with a scrolled menu list. If the current screen displays a part of content, the image display apparatus 100 may change the current screen to a content zoom-in screen.

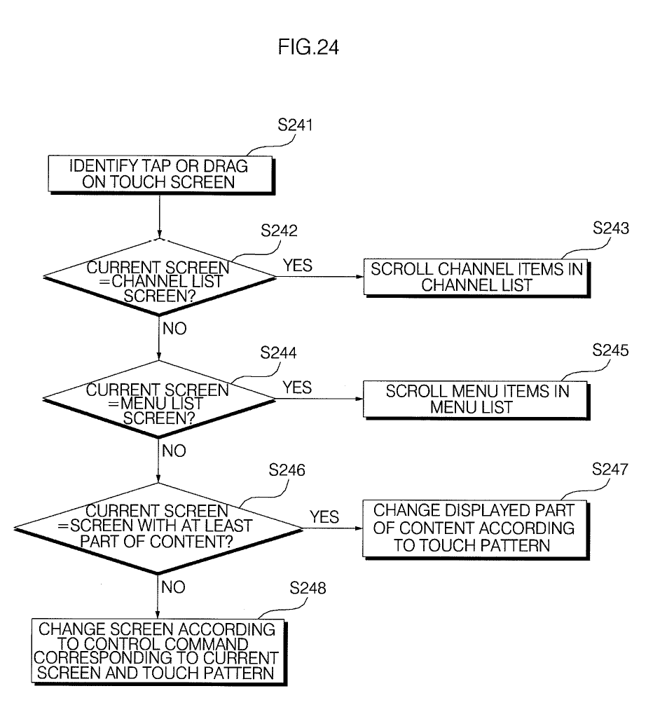

FIG. 24 is a flowchart illustrating a method for controlling an operation of the image display apparatus according to an embodiment of the present invention.

Referring to FIG. 24, the image display apparatus 100 identifies a user touch pattern on the touch screen from a signal including information about the touch pattern received from the remote controller 201 (S241). In this embodiment, the user may tap or drag the touch screen. The remote controller 201 transmits a signal including information about at least one of a tapped area of the touch screen, the number of taps, or a dragging direction to the image display apparatus 100. The image display apparatus 100 identifies the touch pattern from the touch pattern information included in the received signal.

The image display apparatus 100 determines a current screen displayed on the display 180 (S242). If the current screen includes a channel list, the image display apparatus 100 scrolls channel items of the channel list (S243).

More specifically, the image display apparatus 100 scrolls the channel items in the channel list according to the touch pattern. For example, if the user taps the upper part of the touch screen of the remote controller 201, the image display apparatus 100 scrolls up the channel items of the channel list, one by one. In another example, if the user taps a lower part of the touch screen of the remote controller 201, the image display apparatus 100 scrolls down the channel items of the channel list, one by one. In a further example, if the user drags a touch on the touch screen, the image display apparatus 100 scrolls the channel items of the channel list in the dragging direction. In this case, the number and speed of scrolled channels depend on the dragging speed or a dragged area.

While scrolling the channel items, the image display apparatus 100 may highlight a channel item at the center of the channel list. Also, the image display apparatus 100 may tune in to a channel corresponding to the highlighted channel item. When the channel list is scrolled in response to a drag on the touch screen, a channel item moved to the center of the channel list may be highlighted after scrolling. The image display apparatus 100 may tune to a channel corresponding to the highlighted channel item.

The image display apparatus 100 may determine whether the current screen includes a menu list (S244). If the current screen includes a menu list, the image display apparatus 100 scrolls menu items included in the menu list (S245).

More specifically, the image display apparatus 100 scrolls menu items of the menu list according to the touched area or dragging direction of the touch screen. For example, upon determining that the upper part of the touch screen has been tapped, the image display apparatus 200 scrolls up the menu items in the menu list. In another example, upon determining that the user has touched the touch screen and then dragged the touch toward the upper part of the touch screen, the image display apparatus 100 scrolls up the menu items in the menu list. After scrolling, the image display apparatus 100 may highlight a menu item nearest to the center of the display 180.

The image display apparatus 100 determines whether the current screen displays at least a part of content (S246). If at least a part of content is displayed on the current screen, the image display apparatus 100 may change the displayed area of the content (S247).

More specifically, when the user taps on the touch screen of the remote controller 102 twice, the image display apparatus 100 may zoom in or zoom out a part of the content displayed at a position of the display 180, corresponding to a double-tapped area. In another example, if the user touches and then drags the touch on the touch screen, the image display apparatus 100 may move the content in the dragging direction or may zoom in or zoom out the displayed content in the dragging direction.

If the current screen does not display any of channel list, a menu list, and at least a part of content, the image display apparatus 100 determines a control command corresponding to the current screen and the touch pattern and changes the current screen according to the determined control command (S248).

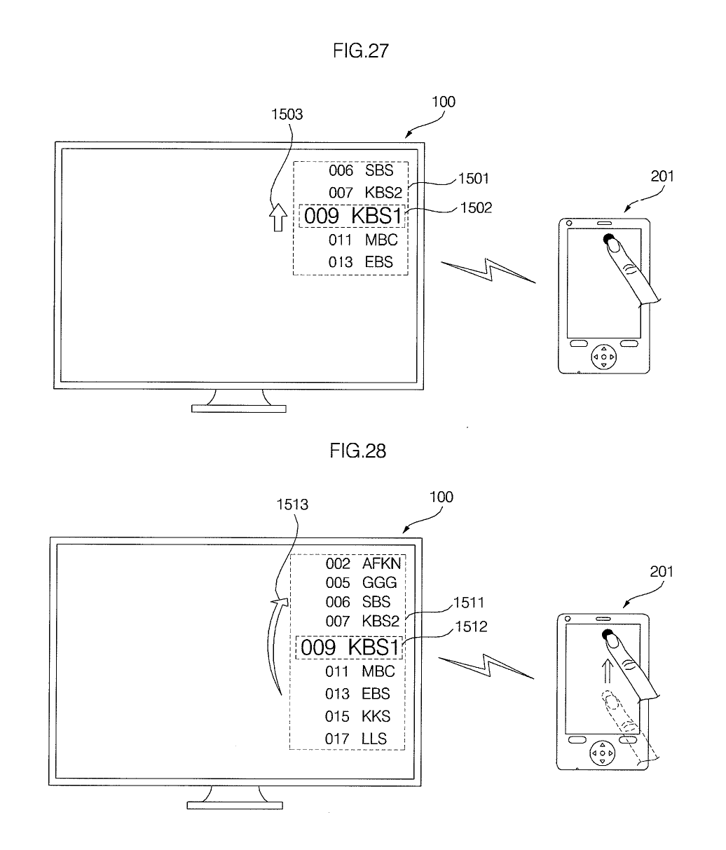

FIGS. 27 and 28 illustrate examples in which the image display apparatus 100 changes a current screen according to manipulation of the remote controller 201 according to an embodiment of the present invention.

Referring to FIG. 27, the user may tap on an upper part of the touch screen of the remote controller 201. The remote controller 201 may change the brightness of the tapped area of the touch screen to thereby allow the user to confirm his or her tap.

In this embodiment, the image display apparatus 100 displays a channel list 1501 on the display 180. A highlighted channel item 1502 in the channel list 1501 represents a channel to which the image display apparatus 100 is currently tuned. When the user taps on the upper part of the remote controller 201, the image display apparatus 100 scrolls up the channel items of the channel list, one by one.

The image display apparatus 100 may display an arrow object 1503 indicating a scroll direction on the display 180. Thus the user is aware of the scroll direction of the channel items from the arrow object 1503.

Referring to FIG. 28, the user may touch a lower part of the touch screen and then drag the touch to the upper part of the touch screen. Then the remote controller 201 transmits a signal including information about the dragging direction, etc. to the image display apparatus 100.

The image display apparatus 100 displays a channel list 1511 on the display 180. A highlighted channel item 1512 in the channel list 1511 represents a channel to which the image display apparatus 100 is currently tuned. When the user drags a touch on the touch screen of the remote controller 201, the image display apparatus 100 scrolls the channel items of the channel list 1511.

The image display apparatus 100 may display an arrow object 1513 indicating a scroll direction on the display 180. Thus the user is aware of the scroll direction of the channel items from the arrow object 1513.

The image display apparatus 100 scrolls the channel items of the channel list faster in FIG. 28 than in FIG. 27. The user may scroll the channel items one by one by tapping on the touch screen or may scroll a plurality of channel items at one time by touching and then dragging the touch on the touch screen.

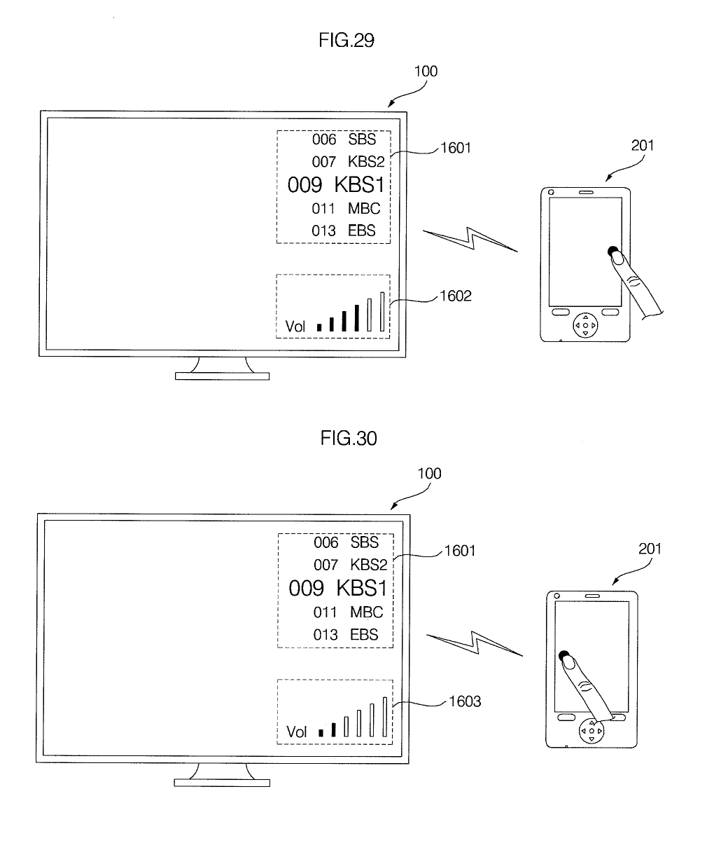

FIGS. 29 and 30 are views referred to for describing a method for controlling an operation of the image display apparatus 100 according to an embodiment of the present invention.

In this embodiment, the image display apparatus 100 displays a channel list 1601 on the display 180. The user may tap on a left or right part of the touch screen of the remote controller 201, as illustrated in FIGS. 29 and 30.

The image display apparatus 100 may control sound volume in correspondence with the tapped area of the touch screen. More specifically, upon determining that the user has tapped on the right part of the remote controller 201, the image display apparatus 100 may increase the sound volume. On the other hand, upon determining that the user has tapped on the left part of the remote controller 201, the image display apparatus 100 may decrease the sound volume.

The image display apparatus 100 displays volume objects 1602 and 1603 representing the sound volume adjusted according to a control command corresponding to a signal received from the remote controller 201.

More specifically, when the user taps on the right part of the touch screen of the remote controller 201 as illustrated in FIG. 29, the image display apparatus 100 increases its output sound volume. At the same time, the image display apparatus 100 displays the volume object 1602 representing the increased sound volume on the display 180. When the user taps on the left part of the touch screen of the remote controller 201 as illustrated in FIG. 30, the image display apparatus 100 decreases output sound volume. At the same time, the image display apparatus 100 displays the volume object 1603 representing the decreased sound volume on the display 180.

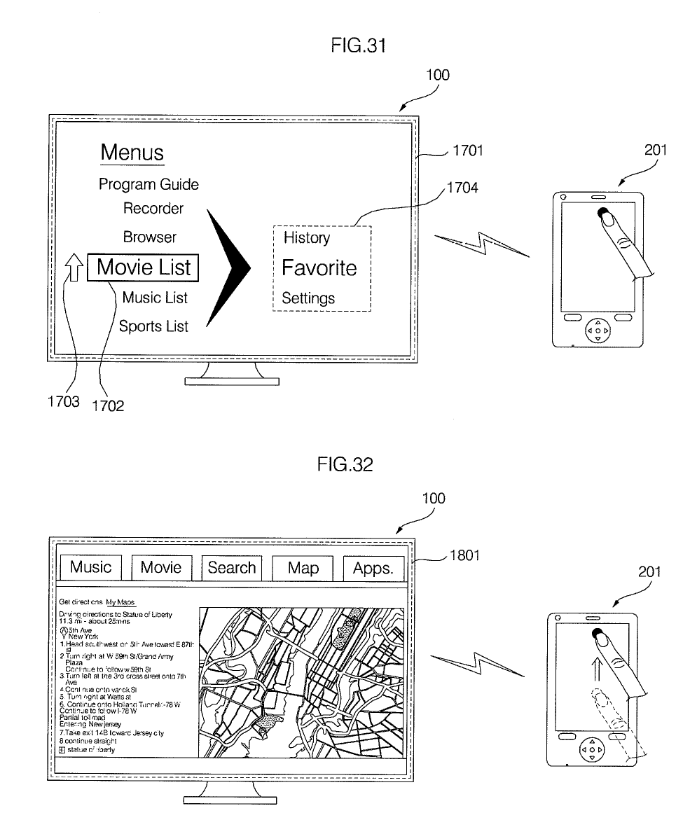

FIG. 31 is a view referred to for describing a method for controlling an operation of the image display apparatus 100 according to an embodiment of the present invention.

Referring to FIG. 31, the image display apparatus 100 displays a screen 1701 including a menu list on the display 180. In this embodiment, the image display apparatus 100 scrolls menu items in the menu list according to a user touch pattern of the touch screen indicated by the remote controller 201.

More specifically, the image display apparatus 100 displays a program guide list with Recorder, Browser, Movie List, Music List, and Sports List as menu items. Upon determining that the user has tapped on the upper part of the touch screen of the remote controller 201, the image display apparatus 100 scrolls the menu items of the program guide list, one by one. In addition, the image display apparatus 100 displays an object 1703 indicating a scroll direction on the display 180.

In the embodiment of the present invention, a highlighted menu item is the Movie List menu item displayed nearest to the center of the display 180. The image display apparatus 100 may display a sub-menu list of the highlighted menu item on the display 180. Thus, the image display apparatus 100 displays a sub-menu list 1704 of the Movie List menu item.

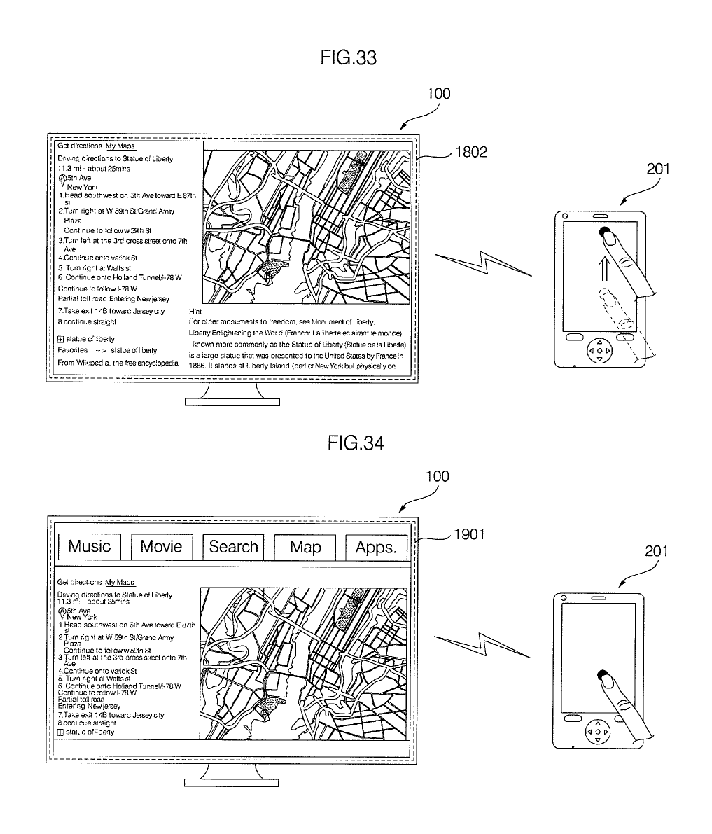

FIGS. 32 and 33 are views referred to for describing screens displayed on the image display apparatus 100 according to an embodiment of the present invention.

Referring to FIG. 32, the image display apparatus 100 may display a part of content on the display 180. More specifically, the image display apparatus 100 may display a part 1801 of a Web page on the display 180.

When the user touches and then drags the touch on the touch screen, the image display apparatus 100 may change the displayed part 1801 of the Web page. The image display apparatus 100 determines the dragging direction and moves the displayed part of the Web page in the dragging direction.

More specifically, the user may touch the lower part of the touch screen and then drag the touch to the upper part of the touch screen, as illustrated in FIG. 32. Then the remote controller 201 transmits a signal including touch pattern information about the dragging direction, etc. to the image display apparatus 100.

The image display apparatus 100 receives the signal from the remote controller 201 and determines the dragging direction from the touch pattern information included in the received signal. The image display apparatus 100 moves the displayed part of the Web page displayed on the display 180 in the dragging direction.

FIG. 33 illustrates a screen 1802 displayed on the display 180 of the image display apparatus 100, after the Web page was shifted in the dragging direction. Specifically, the image display apparatus 100 moves up the Web page on the display 180. The user may move the content displayed on the display 180 up, down, to the left or to the right by dragging a touch on the touch screen.

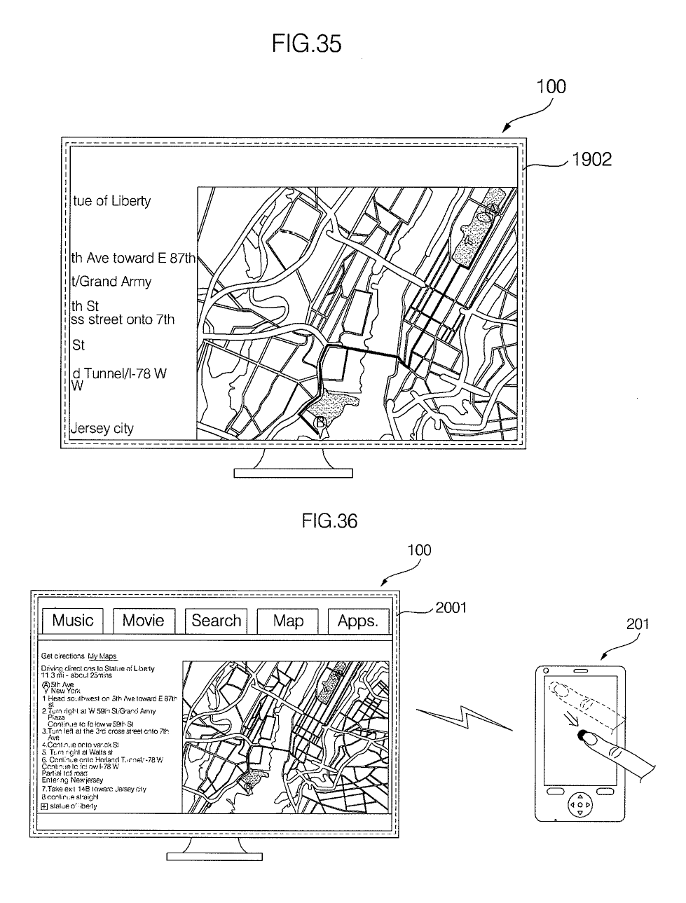

FIGS. 34 and 35 are views referred to for describing screens displayed on the image display apparatus 100 according to an embodiment of the present invention.

Referring to FIG. 34, the image display apparatus 100 displays a screen 1901 including a part of a Web page. The user may tap the center of the touch screen of the remote controller 201 twice. The remote controller 201 may transmit a signal including information about the double-tapped area of the remote controller 201 to the image display apparatus 100.

The image display apparatus 100 receives the signal from the remote controller 201 and determines the double-tapped area based on the tapped area information included in the received signal. Then the image display apparatus 100 determines a part of the display 180 corresponding to the double-tapped area and zooms in or zooms out the content displayed on the determined part of the display 180.

FIG. 35 illustrates a screen 1902 having the zoomed-in content displayed on the display 180 of the image display apparatus 100. In this embodiment, when the user taps the center of the touch screen of the remote controller 201 twice, the image display apparatus 100 zooms in on a part of the content, which is displayed at the center of the display 180.

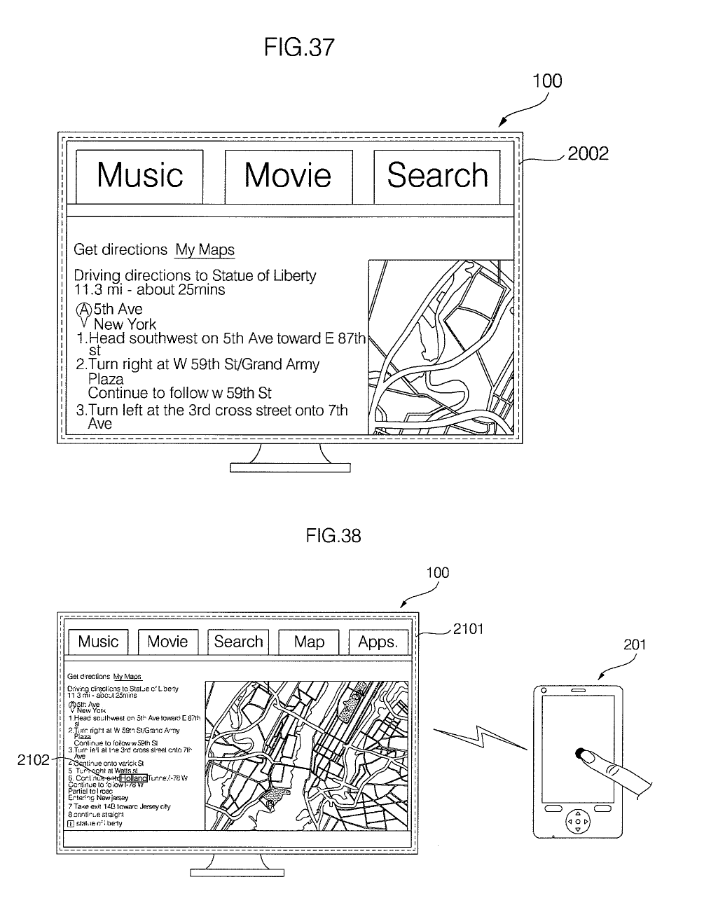

FIGS. 36 and 37 illustrate screens displayed on the image display apparatus 100 according to an embodiment of the present invention.

In this embodiment, the image display apparatus 100 displays a part of a Web page on the display 180. FIG. 36 illustrates a screen 2001 displayed on the display 180 of the image display apparatus 100. The user may input a Web page zoom-in command to the image display apparatus 100. More specifically, the user may touch a top left part of the touch screen and then drag the touch in an arrowed direction.

Then the remote controller 201 transmits a signal including information about the dragging direction, etc. to the image display apparatus 100. The image display apparatus 100 receives the signal and determines the dragging direction based on the information included in the received signal.

If the image display apparatus 100 is now displaying a part of a Web page, it determines from the dragging direction that a Web page zoom-in control command has been received. Thus the image display apparatus 100 zooms in the Web page on the display 180 according to the Web page zoom-in command.

FIG. 37 illustrates a screen 2002 displayed on the image display apparatus 100, in which the left top part of the Web page has been zoomed in on. Referring to FIG. 37, the image display apparatus 100 zooms in the top left part of the Web page on the display 180 according to the signal received from the remote controller 201.

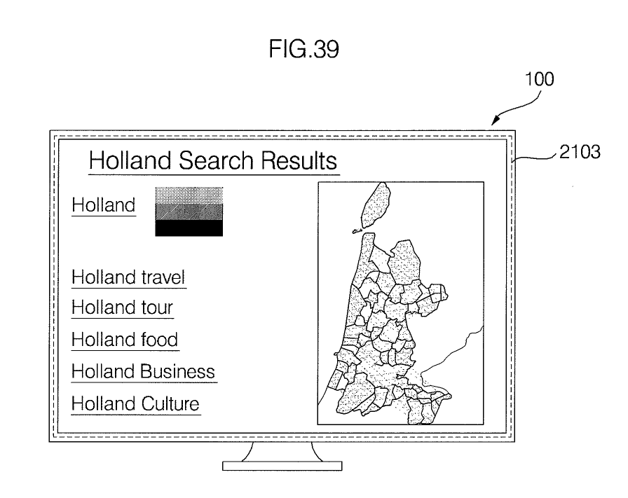

FIGS. 38 and 39 illustrate screens displayed on the image display apparatus 100 according to an embodiment of the present invention.

In this embodiment, the image display apparatus 100 displays a screen 2101 including a part of a Web page in FIG. 38. The image display apparatus 100 highlights a link area 2101 on the Web page. Specifically, the image display apparatus 100 may highlight all link areas 2102 on the Web page. In addition, when the displayed part of the Web page is moved on the display 180, a link area 2102 nearest to the center of the display may be highlighted.

The user may input a link area selection command to the image display apparatus 100 by tapping the touch screen of the remote controller 201 twice. The remote controller 201 transmits a signal including information about the touch pattern to the image display apparatus 100. Upon determining that the touch pattern information indicates double taps on the touch screen and the current Web page includes a highlighted link area, the image display apparatus 100 determines that a link area selection command has been received.

The image display apparatus 100 changes the current screen 2101 according to the determined control command. In this embodiment, the image display apparatus 100 displays a Web page linked to the link area 2102 on the display 180.

FIG. 39 illustrates a screen 2103 including the Web page linked to the link area, displayed on the display 180.

As described above, the user can control the image display apparatus 100 by touching the touch screen of the remote controller 201 in the embodiment of the present invention.

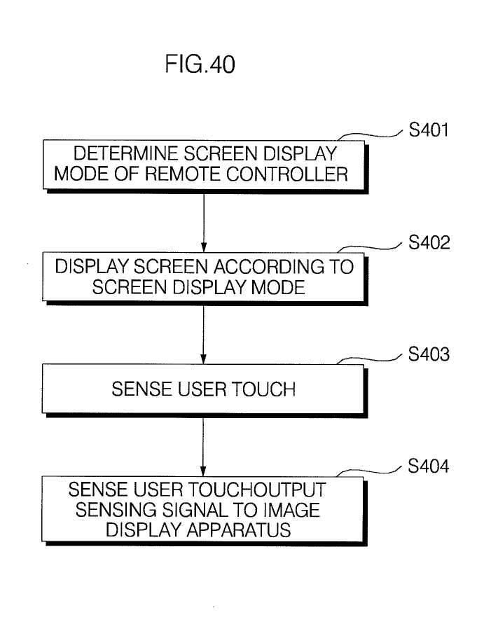

FIG. 40 is a flowchart illustrating a method for operating the remote controller according to an embodiment of the present invention.

Referring to FIG. 40, the controller 204 of the remote controller 201 determines a current screen display mode (S401). In the embodiment of the present invention, screen display modes of the remote controller 201 may be classified according to UIs illustrated on the touch screen of the remote controller 201.

The screen display modes of the remote controller 201 include a jog-shuttle UI mode, a button UI mode, and a text UI mode. The screen display mode of the remote controller 201 may be determined according to a user selection command input to the remote controller 201.

For example, the user may input a screen display mode selection command to the remote controller 201 by manipulating a button, a key, or the touch screen of the remote controller 201. Then the remote controller 201 enters a screen display mode indicated by the screen display mode selection command.

In another example, the screen display mode of the remote controller 201 may be determined according to a screen displayed on the image display apparatus 100. Specifically, the image display apparatus 100 may transmit information about the current screen displayed on the display 180 to the remote controller 201. The remote controller 201 receives the screen information from the image display apparatus 100 through the communication module 205 and determines the current screen displayed on the image display apparatus 100 based on the screen information. Then the remote controller 201 may determine its screen display mode such that a UI corresponding to the current screen displayed on the image display apparatus 100 can be displayed on the touch screen.

After determining the screen display mode, the controller 204 of the remote controller 201 outputs an image signal to the display 203 so that a UI corresponding to the screen display mode is displayed on the display 203 (S402). As stated before, the display 203 and the touch sensor 202 collectively form the touch screen. Accordingly, the remote controller 201 displays the UI corresponding to the screen display mode on the touch screen.

Specifically, the UI displayed on the touch screen may include a jog shuttle object, a button object, or a keyboard object. The jog shuttle object takes the form of a jog shuttle. The jog shuttle object may be shaped into a circle with a predetermined spot at its center. The user may input a control command for controlling the image display apparatus 100 to the remote controller 201 by touching the jog shuttle object on the touch screen.

The touch sensor 202 of the remote controller 201 senses a user touch on the UI (S403). As stated before, the touch sensor 202 is included in the touch screen and thus the controller 204 identifies the touch pattern on the touch screen.

The controller 204 transmits a signal including information about the touch pattern to the image display apparatus 100 (S404). The touch pattern information includes the coordinates of the touched area on the touch screen, touch duration, and the number of touches. The image display apparatus 100 is controlled according to a control command included in the signal received from the remote controller 201.

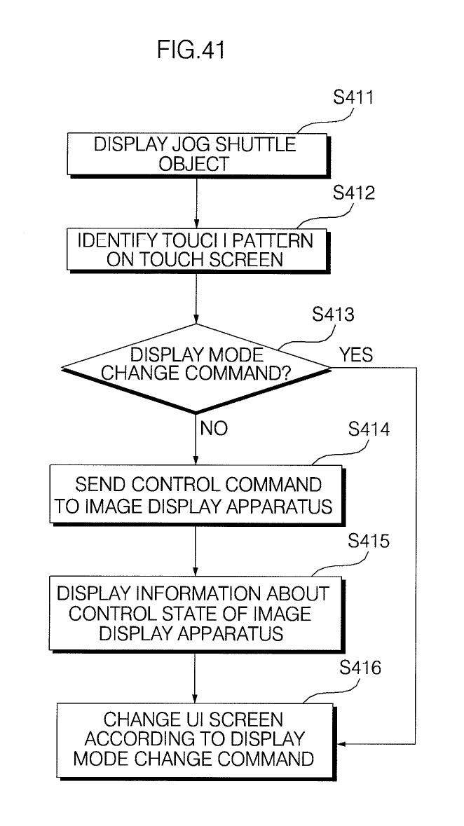

FIG. 41 is a flowchart referred to for describing the method for operating the remote controller 201 according to the embodiment of the present invention.

Referring to FIG. 41, the remote controller 201 may display a jog shuttle object on the touch screen (S411). When the user touches the touch screen having the jog shuttle object displayed thereon, the controller 204 identifies the touch pattern (S412).

The controller 204 determines whether the touch pattern represents a screen display mode change command (S413). For example, when the user touches an area other than the jog shuttle object on the touch screen or when the user touches the jog shuttle object a plurality of times consecutively, the controller 204 may determine that the screen display mode change command has been received.

If the touch pattern does not represent the screen display mode change command, the controller 204 may control the communication module 206 to transmit a control command corresponding to the user touch pattern to the image display apparatus 100 (S414). The control command corresponds to the touch pattern and the touched area. That is, even though the user touches the touch screen in the same touch pattern, different control commands may be transmitted to the image display apparatus 100 in case of a touch on the jog shuttle object and in case of a touch on an area other than the jog shuttle object.

For example, if the control command is an object shift command, the movement distance or speed of an object displayed on the image display apparatus 100 may correspond to the touched area of the touch screen.

After being controlled according to the control command received from the remote controller 201, the image display apparatus 100 may transmit a signal including information about its control state to the remote controller 201. In this case, the remote controller 201 displays information about the control state of the image display apparatus 100 on the touch screen (S415). Thus the user can confirm from the touch screen that the image display apparatus 100 has been controlled according to the control command.

If the user inputs the screen display mode change command to the remote controller by touching the touch screen, the remote controller 201 displays a UI corresponding to the screen display mode change command on the touch screen (S416). For example, the remote controller 201 may display a UI including a button object or a UI including a keyboard object for entering text.

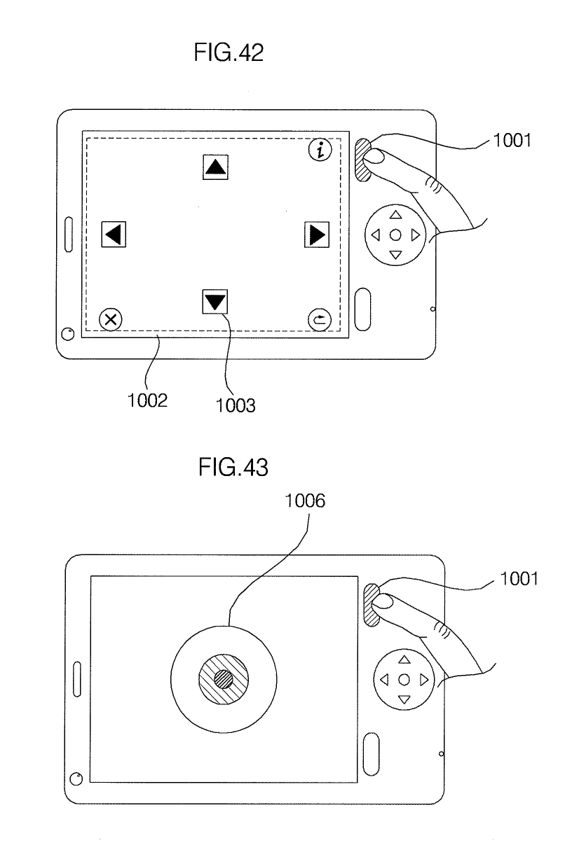

FIGS. 42, 43 and 44 are views referred to for describing Uls displayed on the touch screen including the display 203 and the touch sensor 202 in the remote controller 201 according to an embodiment of the present invention.

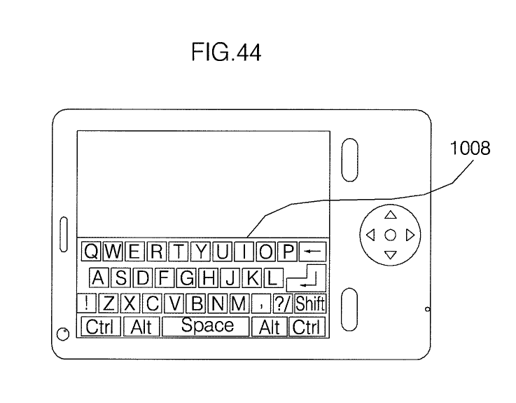

In this embodiment, a button UI screen 1002 (FIG. 42), a jog shuttle UI screen including a jog shuttle object 1006 (FIG. 43), or a text UI screen including a keyboard object 1008 (FIG. 44) may be displayed on the touch screen of the remote controller 201.

The user may input a screen display mode selection command to the remote controller 201 by manipulating a button 1001 or a key or by touching the touch screen of the remote controller 201. In this embodiment, the user inputs a screen display mode selection command to the remote controller 201 by manipulating the button 1001.

The remote controller 201 changes the current UI screen on the touch screen according to the screen display mode selection command. For example, if the remote controller 201 is powered on or transitions from standby mode to active mode, the controller 204 determines the screen display mode of the remote controller 201 to be the button UI mode.

Thus the controller 204 displays the button UI screen 1002 including button objects 1003 on the touch screen. A channel or volume up/down command or an object up/down/left/right selection command may be created for the image display apparatus 100, using the button objects 1003.

When the user touches the touch screen in a specific touch pattern or manipulates the button 1001, the controller 204 determines that the screen display mode change command has been received. Thus the controller 204 determines that the remote controller 201 is to transition to, for example, the jog shuttle UI mode.

Therefore, the controller 201 displays a jog shuttle UI screen including the jog shuttle object 1006 on the touch screen, as illustrated in FIG. 43. When the user touches the jog shuttle object 1006, the remote controller 201 determines that an object (e.g. a cursor or content) shift command has been received. Hence, the remote controller 201 transmits a signal including the object shift command corresponding to the user touch pattern to the image display apparatus 100.

When the user manipulates the button 1001 again on the touch screen, the controller 204 determines that the remote controller 201 is to transition to the keyboard UI mode.

Therefore, the controller 204 displays a UI screen including the keyboard object 1008 on the touch screen, as illustrated in FIG. 44. When the user touches the keyboard object 1008, the remote controller 201 determines that a text send command corresponding to the touched key has been received. Thus the remote controller 201 transmits a signal including a command corresponding to the user-entered character to the image display apparatus 100.

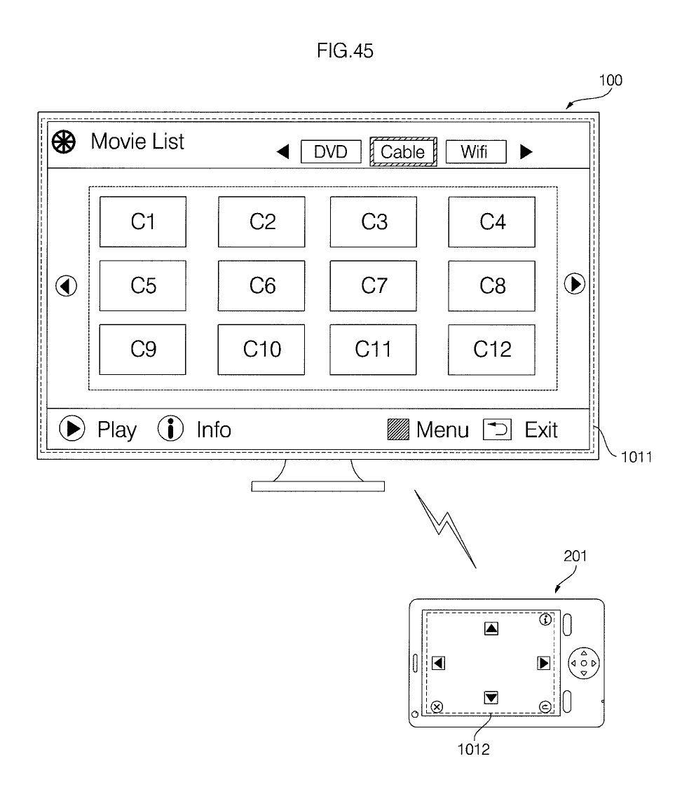

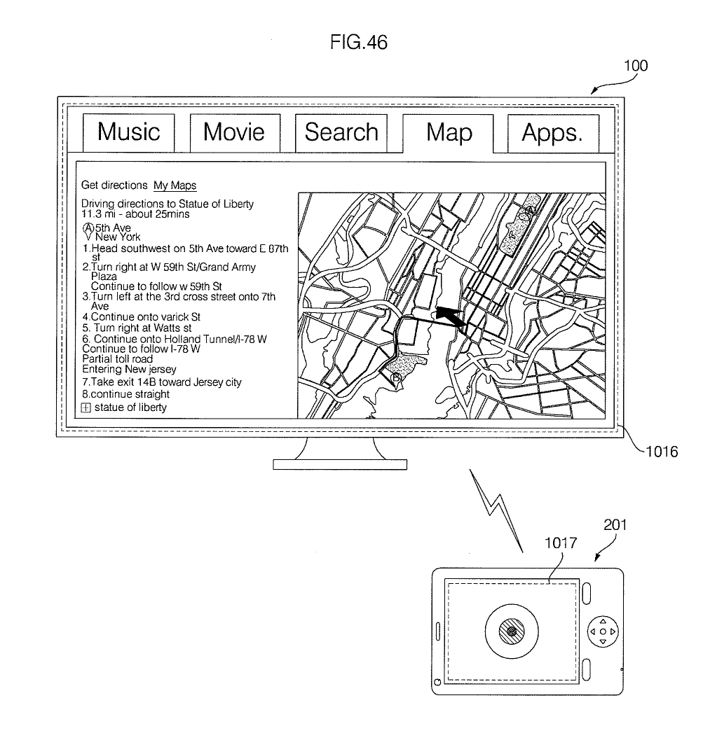

FIGS. 45 and 46 are views referred to for describing the method for controlling an operation of the remote controller 201 according to an embodiment of the present invention. In this embodiment, the remote controller 201 changes a UI screen displayed on the touch screen according to screen information received from the image display apparatus 100.

Referring to FIG. 45, the image display apparatus 100 displays a screen 1011 including objects representing content, so that the user may be aware of content viewable on the image display apparatus 100. In this embodiment, the content viewable on the image display apparatus 100 may include moving pictures and/or still images.

The remote controller 201 receives a signal including screen information from the image display apparatus 100 through the communication module 206. The controller 204 determines that the current screen 1011 of the image display apparatus 100 includes a list of content objects. The remote controller 201 then displays a UI screen 1012 suitable for controlling the image display apparatus 100 that is displaying the content object list, on the touch screen.

In the embodiment of the present invention, upon determining that the image display apparatus 100 is displaying a content object list, the remote controller 201 determines its screen display mode to be the button UI mode. Accordingly, the remote controller 201 displays the UI screen 1012 on the touch screen, as illustrated in FIG. 45.

The user may input a control command for controlling the image display apparatus 100 to the remote controller 201 by touching a button object on the button UI screen 1012. When the user touches a button object on the button UI screen 1012, the remote controller 201 may determine that an object selection command for selecting a content object displayed on the image display apparatus 100 has been received. Then the remote controller 201 may transmit a signal including the content object selection command to the image display apparatus 100.

FIG. 46 is a view referred to for describing a screen displayed on the remote controller 201, when a Web page screen 1016 is displayed on the image display apparatus 100. Referring to FIG. 46, upon determining that the image display apparatus 100 is displaying the Web page screen 1016, the controller 204 determines that the remote controller 201 is to be placed in the jog shuttle UI mode.

Hence, the remote controller 201 displays a UI screen 1017 including a jog shuttle object on the touch screen. The user may input an object shift command to the remote controller 201 by touching the jog shuttle object on the jog shuttle UI screen 1017, in order to move an object displayed on the image display apparatus 100.

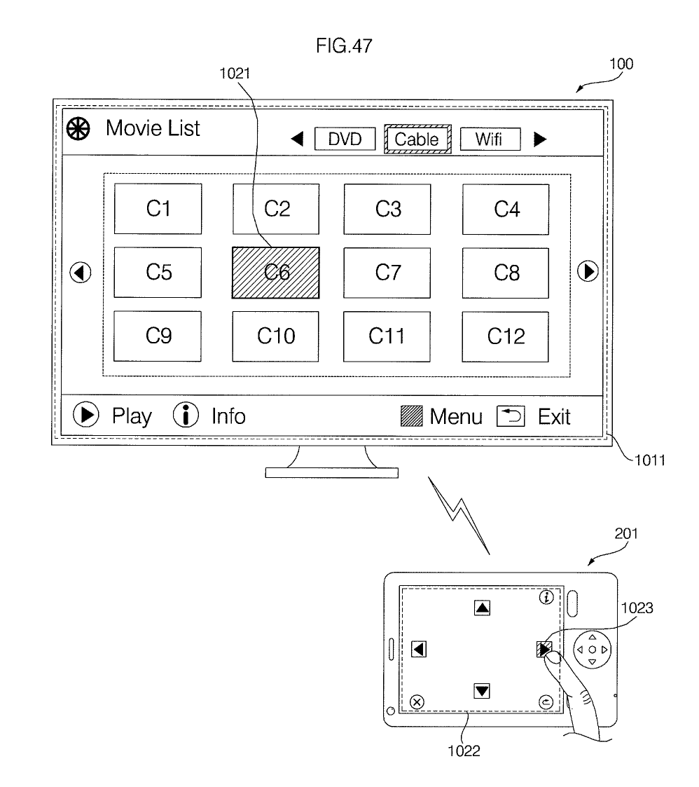

FIG. 47 is a view referred to for describing a case in which a button UI screen 1022 is displayed on the remote controller 201 according to an embodiment of the present invention. The remote controller 201 may transmit a control command to the image display apparatus 100 that is displaying the content object list screen 1011.

In the embodiment of the present invention, the remote controller 201 may determine that the remote controller 201 is to be placed in the button UI mode, based on screen information received from the image display apparatus 100. Alternatively or additionally, the remote controller 201 may determine its screen display mode to be the button UI mode based on a UI mode selection command received from the user. The user may input a UI mode selection command to the remote controller 201 by manipulating a specific button or key of the remote controller 201 or touching the touch screen of the remote controller 201 in a predetermined touch pattern.

The remote controller 201 transmits a control command corresponding to a user-touched button object on the button UI screen 1022 to the image display apparatus 100. The control command is a command to select a content object displayed on the image display apparatus 100 in this embodiment.

The image display apparatus 100 highlights a content object 1021 indicated by the content object selection command included in the received signal. The image display apparatus 100 may change the highlighted content object 1021 according to a command included in a signal received from the remote controller 201.

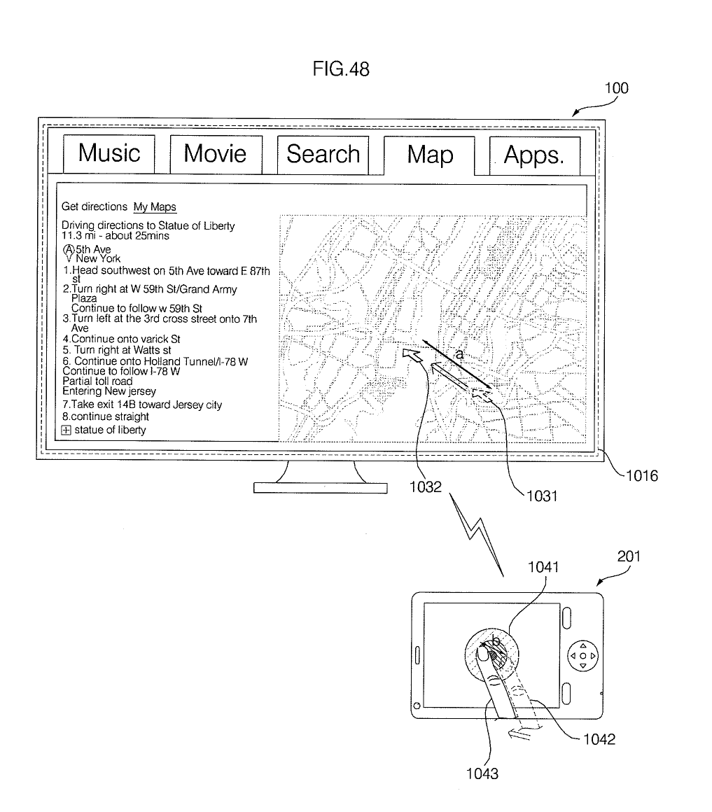

FIG. 48 is a view referred to for describing a case in which a jog shuttle UI screen is displayed on the touch screen of the remote controller 201 according to an embodiment of the present invention.

Referring to FIG. 48, the user may touch the touch screen on which a UI screen including a jog shuttle object 1041 is displayed. In this embodiment, the user touches a specific area of the jog shuttle object 1041 and drags the touch for a distance b, as indicated by reference numerals 1042 and 1043.

In the embodiment of the present invention, the remote controller 201 in the jog shuttle UI mode transmits an object shift command to the image display apparatus 100. That is, the remote controller 201 transmits an object shift command corresponding to the user touch pattern or the touched area. The image display apparatus 100 may move an object displayed on the display 180 according to the object shift command. In this embodiment, the image display apparatus 100 moves a displayed pointer according to the object shift command.

More specifically, the image display apparatus 100 moves the currently displayed pointer for a distance a, as indicated by reference numerals 1031 and 1032. The user may move the pointer using the jog shuttle object 1041 of the remote controller 201.

In the embodiment of the present invention, the movement distance or speed of an object displayed on the image display apparatus 100 corresponds to a touch pattern and a touched area of the touch screen. That is, as a drag occurs at a position nearer to the center of the jog shuttle object, the object displayed on the image display apparatus 100 moves farther or faster.

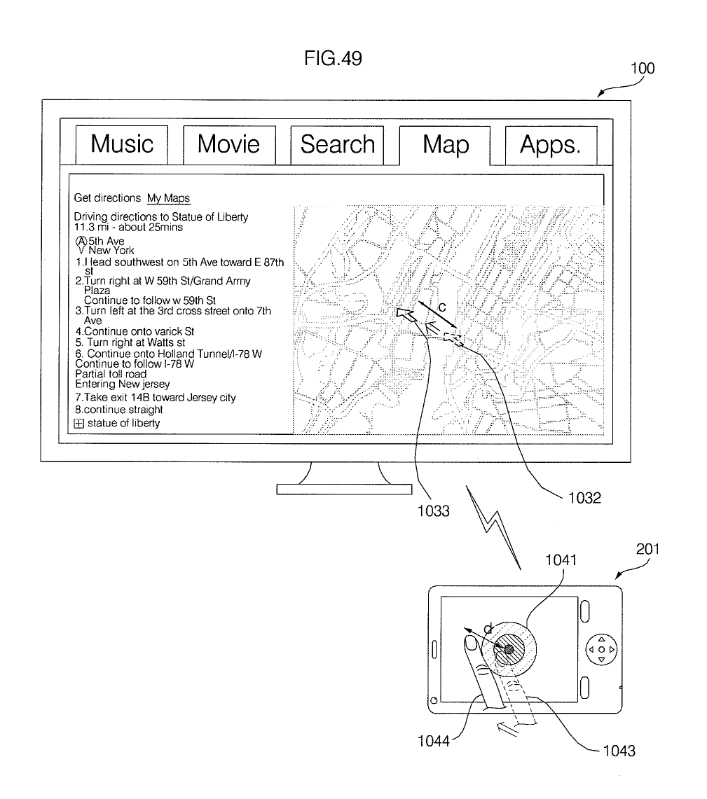

Referring to FIG. 49, the user touches a specific area of the touch screen and drags the touch for a distance d as indicated by reference numerals 1043 and 1044. The remote controller 201 identifies the touch pattern and transmits an object shift command corresponding to the touch pattern to the image display apparatus 100. Then the image display apparatus 100 moves a displayed pointer for a distance c according to the received object shift command as indicated by reference numerals 1032 and 1033.

In this embodiment, although the user drags his or her finger for the same distance in FIGS. 48 and 49 (b=d), the touched area is nearer to the center of the jog shuttle object 1041 in FIG. 48 than in FIG. 49. As a consequence, the pointer moves farther in FIG. 48 than in FIG. 49 (a>b).

As another embodiment, it may be contemplated that the speed of the pointer displayed on the image display apparatus 100 is determined according to a touched area of the touch screen.

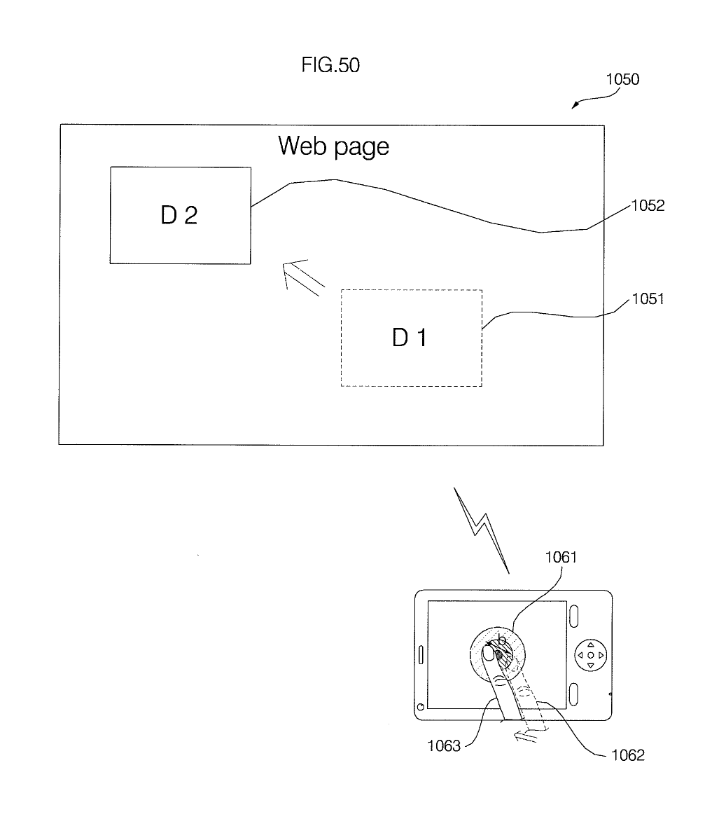

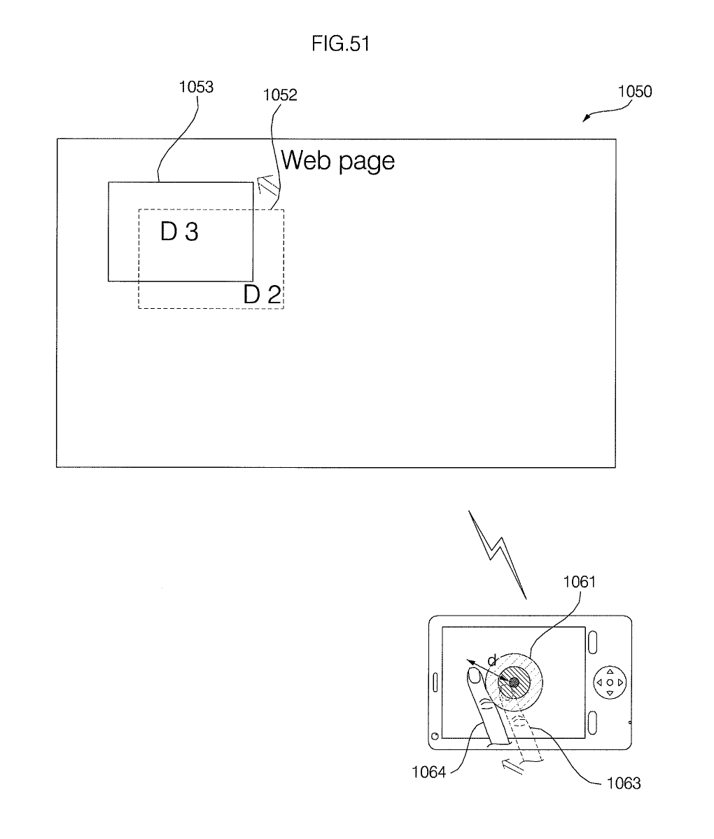

FIGS. 50 and 51 are views referred to for describing a case in which a jog shuttle object 1061 is displayed on the touch screen of the remote controller 201 according to an embodiment of the present invention.

In this embodiment, the image display apparatus 100 displays specific areas of a Web page 1050, specifically areas D1 and D2 in FIG. 50 and areas D2 and D3 in FIG. 51, on the display 180.

Referring to FIG. 50, the user may touch a specific area of the jog shuttle object 1061 on the touch screen and then drag the touch as indicated by reference numerals 1062 and 1063. Then the remote controller 201 identifies the touch pattern and transmits an object shift command corresponding to the touch pattern to the image display apparatus 100.

In FIG. 50, the object shift command instructs movement of a part of the Web page 1050 displayed on the area D1. Thus the image display apparatus 100 moves the Web page 1050 according to the received object shift command. That is, the image display apparatus 100 shifts the part of the Web page displayed on the area D1 to the area D2 on the display 180 according to the signal received from the image display apparatus 100.

Referring to FIG. 51, the user may touch a specific area of the jog shuttle object 1061 on the touch screen and then drag the touch as indicated by reference numerals 1063 and 1064. Then the remote controller 201 identifies the touch pattern and transmits an object shift command corresponding to the touch pattern to the image display apparatus 100.

In FIG. 51, the object shift command instructs movement of the part of the Web page 1010 displayed on the area D2. The image display apparatus 100 moves the Web page 1050 according to the received object shift command. That is, the image display apparatus 100 shifts the part of the Web page 1010 displayed on the area D2 to the area D3 on the display 180 according to the signal received from the image display apparatus 100.

The touched area is nearer to the center of the jog shuttle object 1061 in FIG. 50 than in FIG. 51. As a result, the Web page 1050 is moved a greater distance in FIG. 50 than in FIG. 51.

The user may change the size or shape of an object displayed on the touch screen of the remote controller 201.

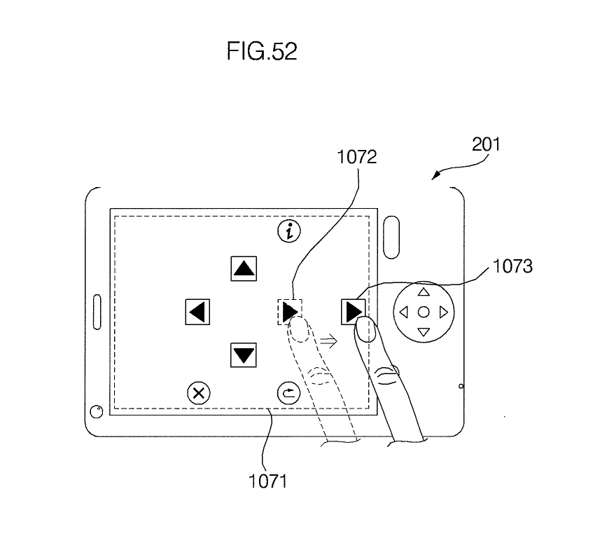

Referring to FIG. 52, the remote controller 201 is placed in the button UI mode. Thus the remote controller 201 displays a button UI screen 1071 on the touch screen. The user may touch a button object included in the button UI screen 1071. Then, the remote controller 201 determines that a control command corresponding to the touched button object has been received and transmits a signal including the control command to the image display apparatus 100.

The user may also move a button object as indicated by reference numerals 1072 and 1073 on the button UI screen 1071. More specifically, the user may touch a desired button object and then drag the button object to the right in the arrowed direction.

In this case, the remote controller 201 moves the touched button object in the dragging direction. The user may change the displayed area of a button object on the button UI screen 1071 in this manner.

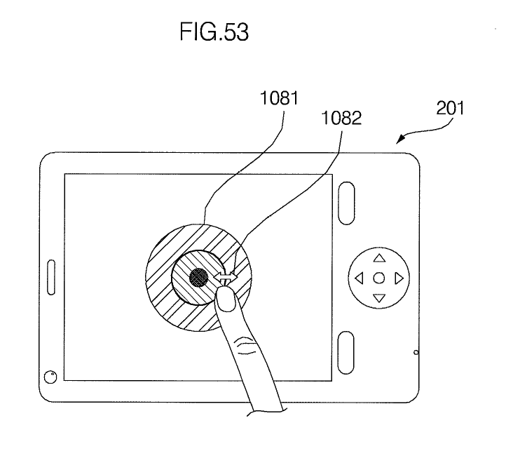

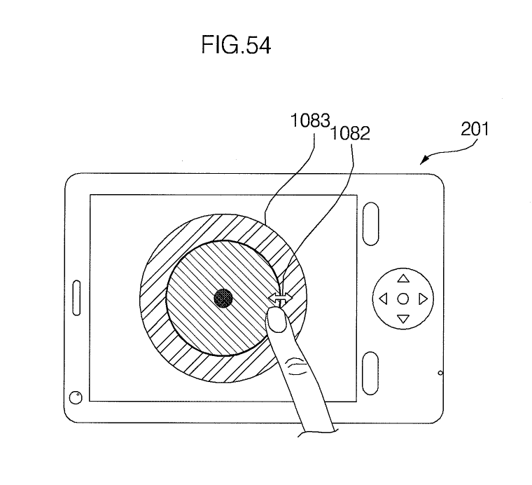

FIGS. 53 and 54 illustrate the remote controller 201 in the jog shuttle UI mode.

In this embodiment, the remote controller 201 displays a jog shuttle object 1081 on the touch screen. The jog shuttle object 1081 is divided into at least two areas each corresponding to a control command for the image display apparatus 100. The same touch pattern information may lead to transmission of different control commands and accordingly control the image display apparatus 100 in different ways, according to a touched area.

Referring to FIG. 53, the user may touch an area of the jog shuttle object 1081, corresponding to an object shape or size change command. In this case, the remote controller 201 displays an arrow object 1082 on the touch screen. Thus the user can confirm that the jog shuttle object change command has been input to the remote controller 201.

Referring to FIG. 54, the user may drag the touch to the right. The remote controller 201 displays an enlarged jog shuttle object 1082 on the touch screen. In this manner, the user can scale up or down the jog shuttle object 1083 on the touch screen.

As is apparent from the above description of the embodiments of the present invention, a remote controller capable of transmitting a control command to an image display apparatus includes a touch screen. A user may touch the touch screen of the remote controller in a specific touch pattern. Then the remote controller transmits a signal including information about the touch pattern on the touch screen to the image display apparatus. The image display apparatus is controlled according to a control command corresponding to the touch pattern identified from the received signal.

Especially, a control command for controlling the image display apparatus corresponds to a current screen displayed on the image display apparatus and the touch pattern of the remote controller. Therefore, the image display apparatus determines the touch pattern from the signal received from the remote controller and the current screen displayed on the image display apparatus and then determines a control command corresponding to the touch pattern and the current screen. The image display apparatus is controlled according to the determined control command.

Accordingly, the user can control the image display apparatus using the remote controller having a touch screen, especially by simply touching the touch screen.

The image display apparatus and the method for operating the same according to the foregoing exemplary embodiments are not restricted to the exemplary embodiments set forth herein. Therefore, variations and combinations of the exemplary embodiments set forth herein may fall within the scope of the present invention.

For example, while various controls (volume, channel, genre, menu, data/image scrolling, display mode, zoom, etc.) have been discussed above, other controls are possible (e.g., image characteristic (e.g., color or tint), clock control, record or reproduce controls, etc.)

The method for operating an image display apparatus according to the foregoing exemplary embodiments may be implemented as code that can be written on a computer-readable recording medium and can thus be read by a processor. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission over the Internet). The computer-readable recording medium can be distributed over a plurality of computer systems connected to a network so that computer-readable code is written thereto and executed therefrom in a decentralized manner. Functional programs, code, and code segments needed for realizing the embodiments herein can be devised by one of ordinary skill in the art.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for operating an image display apparatus configured to be controlled by a wireless remote controller having a touch screen, comprising:
displaying objects on a display of the image display apparatus; and
performing an operation on one of the displayed objects by the image display apparatus corresponding to a touch pattern input on the touch screen of the wireless remote controller.

2. The method of claim 1, wherein the operation comprises one of:
a volume control operation;
a channel control operation;
a picture characteristic control operation;
an image panning operation;
controlling a recording or reproducing of data;
a genre control operation;
a menu control operation;
a clock control operation;
a zoom control operation;
a web search operation; and
a scroll operation.

3. The method of claim 1, further comprising:
selecting the one of the displayed objects based on a user selection via the remote controller.

4. The method of claim 1, wherein the operation is a scroll operation, the method further comprising:
displaying on the image display apparatus a scroll direction icon corresponding to a scroll direction performed on the touch screen of the remote controller.

5. The method of claim 1, wherein the touch pattern comprises one of:
a number of touches applied to the touch screen;
an interval between touches applied to the touch screen;
a touch duration applied to the touch screen;
a touch pressure applied to the touch screen;
a touched area of the touch screen; and
a dragging direction corresponding to a touch-and-drag applied to the touch screen.

6. The method of claim 1, wherein the step of displaying comprises:
displaying the objects on the display of the image display apparatus while causing at least one of the objects or an item within the objects to be simultaneously displayed on the touch screen of the wireless remote controller, and.
selecting the at least one object or the item based on a user selection via the remote controller.

7. The method of claim 1, wherein the step of displaying objects on the display of the image display apparatus comprises:
simultaneously displaying the objects and a broadcast image.

8. An image display apparatus configured to be controlled by a wireless remote controller having a touch screen, comprising:
a display;
a communication unit; and
a controller operatively connected to the display and the communication unit, the controller programmed to
display objects on a display of the image display apparatus, and
perform an operation on one of the displayed objects by the image display apparatus corresponding to a touch pattern input on the touch screen of the wireless remote controller.

9. The image display apparatus of claim 8, wherein the operation comprises one of:
a volume control operation;
a channel control operation;
a picture characteristic control operation;
an image panning operation;
controlling a recording or reproducing of data;
a genre control operation;
a menu control operation;
a clock control operation;
a zoom control operation;
a web search operation; and
a scroll operation.

10. The image display apparatus of claim 8, wherein the controller is further programmed to select the one of the displayed objects based on a user selection via the remote controller.

11. The image display apparatus of claim 8,
wherein the operation is a scroll operation, and
wherein the controller is further programmed to display a scroll direction icon corresponding to a scroll direction performed on the touch screen of the remote controller.

12. The image display apparatus of claim 8, wherein the touch pattern comprises one of:
a number of touches applied to the touch screen;
an interval between touches applied to the touch screen;
a touch duration applied to the touch screen;
a touch pressure applied to the touch screen;
a touched area of the touch screen; and
a dragging direction corresponding to a touch-and-drag applied to the touch screen.

13. The image display apparatus of claim 8, wherein the controller is further programmed to display the objects while causing at least one of the objects or an item within the objects to be simultaneously displayed on the touch screen of the wireless remote controller,
and, wherein the controller is further programmed to select the at least one object or the item based on a user selection via the remote controller.

14. The image display apparatus of claim 8, wherein the controller is further programmed to simultaneously display the objects and a broadcast image.

15. A method of controlling an image display apparatus with a wireless remote controller having a touch screen, comprising:
controlling, with the wireless remote controller, the image display apparatus to display objects; and
controlling, with the wireless remote controller, an operation on one of the displayed objects by the image display apparatus in response to a touch pattern input on the touch screen of the wireless remote controller.

16. The method of claim 15, wherein the operation comprises one of:
a volume control operation;
a channel control operation;
a picture characteristic control operation;
an image panning operation;
controlling a recording or reproducing of data;
a genre control operation;
a menu control operation;
a clock control operation;
a zoom control operation;
a web search operation; and
a scroll operation.

17. The method of claim 15, wherein the operation is a scroll operation, the method further comprising:
controlling, with the wireless remote controller, the image display apparatus to display on the image display apparatus a scroll direction icon corresponding to a scroll direction performed on the touch screen of the remote controller.

18. The method of claim 15, wherein the touch pattern comprises one of:
a number of touches applied to the touch screen;
an interval between touches applied to the touch screen;
a touch duration applied to the touch screen;
a touch pressure applied to the touch screen;
a touched area of the touch screen; and
a dragging direction corresponding to a touch-and-drag applied to the touch screen.

19. The method of claim 15, wherein the step of controlling the image display apparatus to display objects comprises:
controlling, with the wireless remote controller, the image display apparatus to display the objects on the display of the image display apparatus while simultaneously displaying least one of the objects or an item within the objects on the touch screen of the wireless remote controller,
and, further comprising: selecting, with the wireless remote controller, the at least one object or the item based on a user selection via the remote controller.

20. The method of claim 15, wherein the step of controlling the image display apparatus to display objects comprises:
controlling, with the wireless remote controller, the image display apparatus to simultaneously display the objects and a broadcast image.
